(19) United States
(12) Patent Application Publication
(10) Pub. No.: US 2026/0148161 A1
(43) Pub. Date: May 28, 2026

(54) WORKFLOW MANAGEMENT APPLICATION FOR VEHICLE FLEET

(71) Applicant: Textron Inc., Providence, RI (US)

(72) Inventors: Shayne Evan Rimer, North Augusta, SC (US); Logan Bowman, Evans, GA (US); Lance Fielder, Providence, RI (US); Erik J. Burke, Providence, RI (US)

(73) Assignee: Textron Inc., Providence, RI (US)

(21) Appl. No.: 18/960,694

(22) Filed: Nov. 26, 2024

(51) Int. Cl. G06Q 10/0631; G06Q 10/0633; H04W 4/021

(52) U.S. Cl. CPC G06Q 10/06316; G06Q 10/063112; G06Q 10/0633; H04W 4/021

(57) ABSTRACT

A vehicle work management system includes a plurality of work vehicles and a workflow management application utilizing one or more machine learning models. The workflow management application is configured to acquire first workflow management information from the plurality of work vehicles, acquire second workflow management information associated with a plurality of work items, identify, using the one or more machine learning models, a work item of the plurality of work items for a work vehicle of the plurality of work vehicles based on the first workflow management information and the second workflow management information, and provide the work item to the work vehicle.

### BACKGROUND

Off-road machines or vehicles are used in various scenarios for a variety of purposes. For example, all-terrain vehicles (“ATVs”) and utility task vehicles (“UTVs”) may be used for off-road exploration or performing a variety of tasks requiring off-road capabilities. Other

lightweight or recreational machines (e.g., golf carts, lawnmowers, other chore products) can be used in a variety of other contexts to perform specific chores or to make travel between different locations more convenient.

### SUMMARY

One embodiment relates to a vehicle work management system. The vehicle work management system includes a plurality of work vehicles and a workflow management application utilizing one or more machine learning models. The workflow management application is configured to acquire first workflow management information from the plurality of work vehicles, acquire second workflow management information associated with a plurality of work items, identify, using the one or more machine learning models, a work item of the plurality of work items for a work vehicle of the plurality of work vehicles based on the first workflow management information and the second workflow management information, and provide the work item to the work vehicle.

Another embodiment relates to a vehicle work management system. The vehicle work management system includes at least one processing circuit having at least one processor and at least one memory having instructions stored thereon. The instructions, when executed by the at least one processor, cause the at least one processor to acquire vehicle locations for a plurality of work vehicles, acquire work item locations of a plurality of work items, identify, using one or more machine learning models, a work item from the plurality of work items for a work vehicle of the plurality of work vehicles based on the vehicle locations and the work item locations, and provide the work item to the work vehicle.

Still another embodiment relates to a vehicle work management system. The vehicle work management system includes at least one processing circuit having at least one processor and at least one memory having instructions stored thereon. The instructions, when executed by the at least one processor, cause the at least one processor to acquire first workflow management information from a plurality of work vehicles, acquire second workflow management information associated with a plurality of work items, identify, using a machine learning application, a work item of the plurality of work items for a work vehicle of the plurality of work vehicles based on the first workflow management information and the second workflow management information, generate, using the machine learning application, a map depicting a route from a vehicle location of the work vehicle to a work item location of the work item, and providing the map to a display of the work vehicle to be displayed to an operator of the work vehicle.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3A is a perspective view of a vehicle, according to an exemplary embodiment.

FIG. 3B is a perspective view of a vehicle, according to another exemplary embodiment.

FIG. 4 is a schematic block diagram of the vehicles of FIGS. 3A and 3B, according to an exemplary embodiment.

FIG. 5 is another schematic block diagram of the vehicle of FIG. 1, according to an exemplary embodiment.

FIG. 6 is a schematic block diagram of a fleet monitoring and control system including a plurality of the vehicles of FIGS. 1, 3A, and 3B, according to an exemplary embodiment.

FIG. 7 is a vehicle dock interface, according to an exemplary embodiment.

FIG. 8 is the vehicle dock interface of FIG. 7 showing various application widgets implemented therein, according to an exemplary embodiment.

FIG. 9 is a flowchart of a method for generating and populating a vehicle dock interface, according to an exemplary embodiment.

FIG. 10 is a flowchart of a method for managing an enterprise workflow, according to an exemplary embodiment.

FIG. 11 is an enterprise workflow interface, according to an exemplary embodiment.

FIG. 12 is a dynamic work interface, according to an exemplary embodiment.

FIG. 13 is a flowchart of a method for enabling and interactively monitoring various work items, according to an exemplary embodiment.

FIG. 14 is a flowchart of a method for providing a context-based virtual assistant on a vehicle, according to an exemplary embodiment.

FIG. 15 is a schematic block diagram of a vehicle system for deploying and controlling a plurality of deployable accessories from a vehicle, according to an exemplary embodiment.

FIG. 16 is a perspective view of the vehicle system of FIG. 15, according to an exemplary embodiment.

FIG. 17 is a flowchart of a method for deploying and enabling autonomous accessories, according to an exemplary embodiment.

FIG. 18 is a schematic diagram of the vehicle system of FIG. 15 with the plurality of deployable accessories deployed within a work area, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

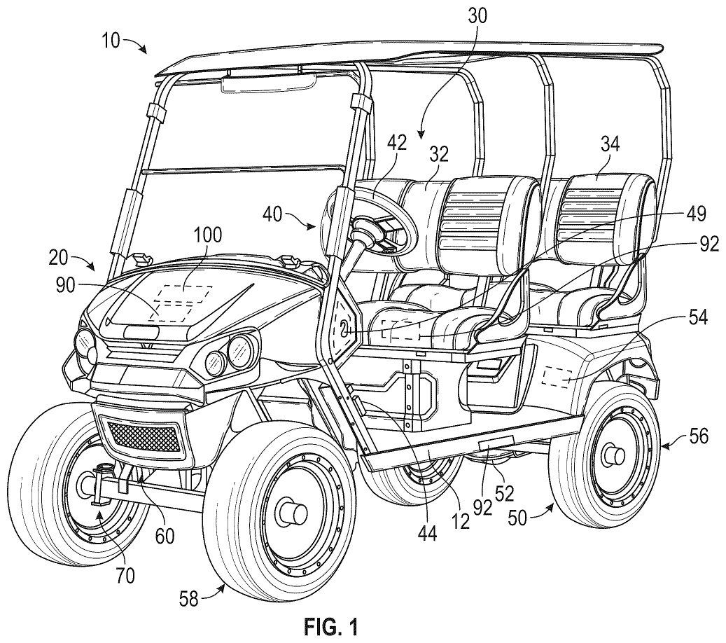

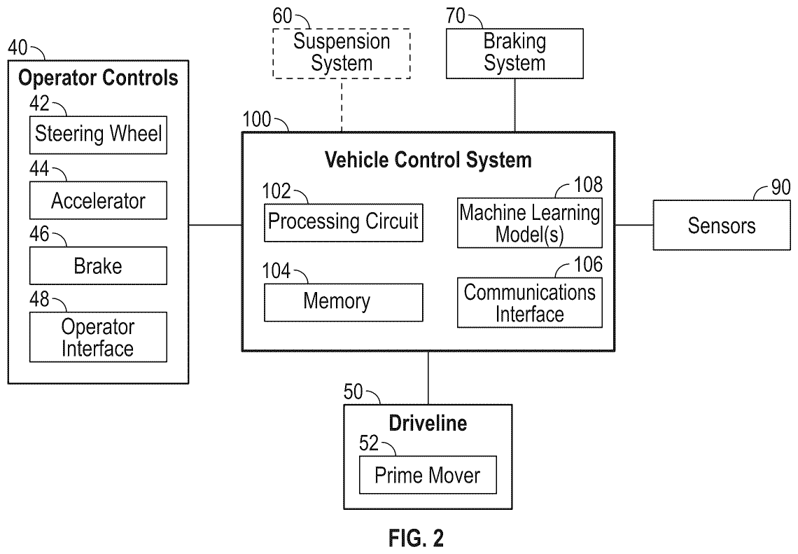

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the operator controls 40, the driveline 50, the suspension system 60, the braking system 70, and the sensors 90. In some embodiments, the vehicle 10 includes more or fewer components.

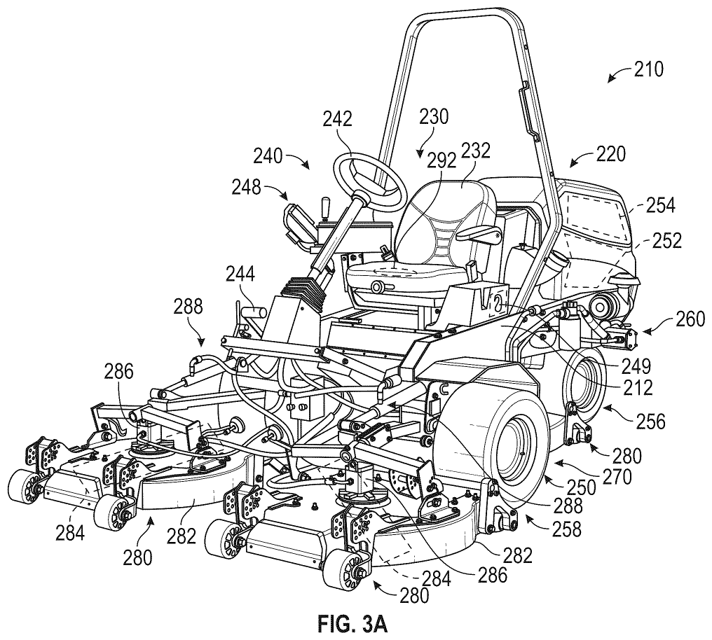

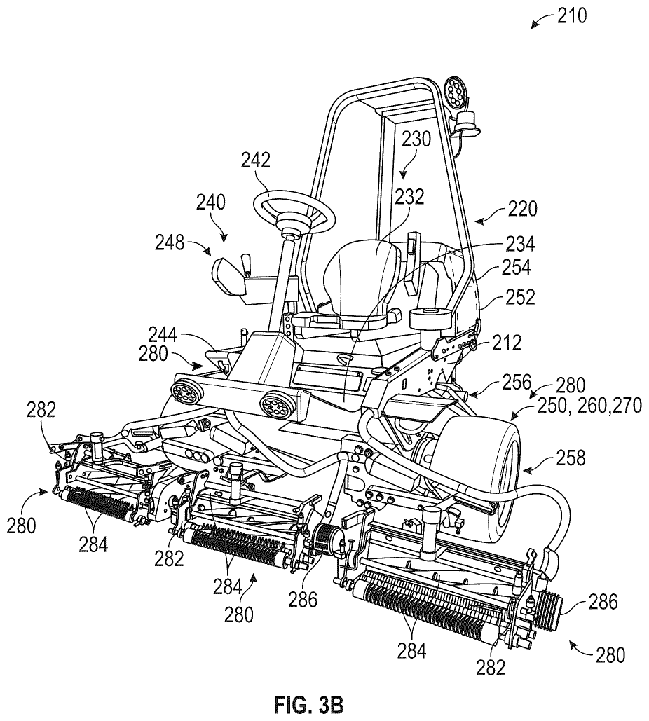

According to an exemplary embodiment, the vehicle 10 is an off-road machine or vehicle. In some embodiments, the off-road machine or vehicle is a lightweight or recreational machine or vehicle such as a golf cart or vehicle, an all-terrain vehicle (“ATV”), a utility task vehicle (“UTV”), a low speed vehicle (“LSV”), a personal transport vehicle (“PTV”), a hauler, a ground support equipment (“GSE”), and/or another type of lightweight or recreational machine or vehicle. In some embodiments, the off-road machine or vehicle is a chore product (e.g., similar to vehicle 210 shown in FIGS. 3A and 3B) such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories. According to an exemplary embodiment, the operator controls 40

are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc. In some embodiments, as shown in FIG. 1, the operator interface 48 includes a remote communication device, shown as removeable earpiece 49. The removeable earpiece 49 is configured to be worn by an operator of the vehicle 10 and to relay audio information, such as a microphone signal of the operators voice and/or audible conversation generated by the vehicle control system 100 (e.g., a virtual assistant) between the vehicle control system 100 and the removeable earpiece 49 (e.g., to be conveyed to the user via a speaker of the removeable earpiece 49).

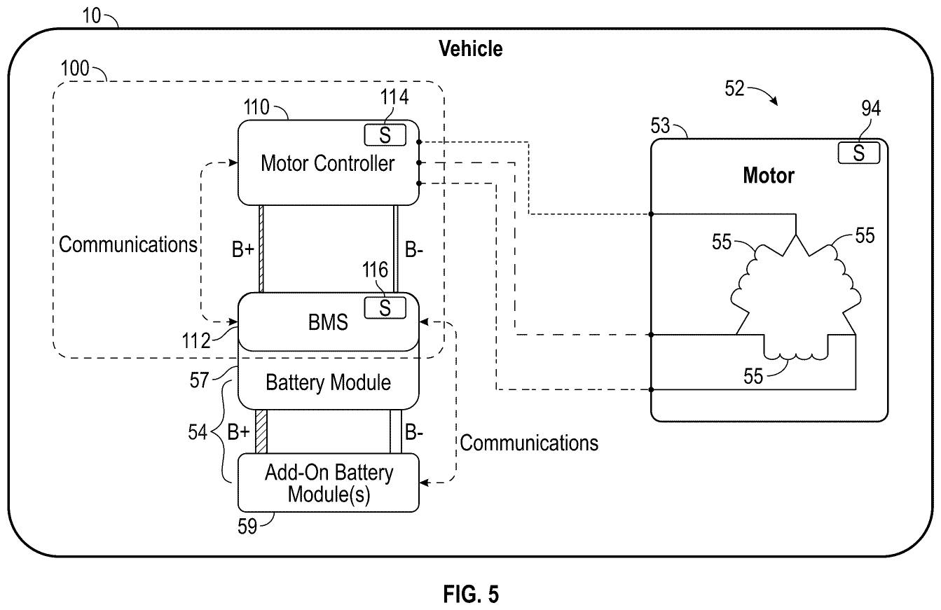

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline (e.g., as shown in FIG. 5) whereby the prime mover 52 is an electric motor (e.g., the motor 53) and the energy storage 54 is a battery system (e.g., the battery module 57, the add-on battery module(s) 59, etc.). In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, electric regenerative braking is employed (e.g., via the prime mover 52, an electric motor, etc.) in combination with or instead of using the braking system 70 to facilitate braking of one or more components of the driveline 50.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, a Doppler sensor, an occupant sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

As shown in FIG. 1, the sensors 90 includes one or more occupant sensors, shown as occupant sensors 92, configured to detect whether an operator or passenger is within the occupant seating area 30. In some embodiments, one or more of the occupant sensors 92 are disposed within or underneath a seat to facilitate detecting whether an occupant is sitting within the occupant seating area 30. In some embodiments, one or more of the occupant sensors 92 are disposed within a floorboard of the vehicle 10 to facilitate detecting whether an occupant has entered or exited the occupant seating area 30. In some embodiments, one or more of the occupant sensors 92 are cameras, proximity sensors, etc. disposed about the occupant seating area 30 and configured to facilitate detecting the presence of an occupant within the occupant seating area 30 (e.g., machine vision, etc.).

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, a communications interface 106, and one or more machine learning models 108. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 represents a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, the removable earpiece 49, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

In some embodiments, the machine learning models 108 include one or more generative artificial intelligence (“GAI”) models, large language models (“LLMs”), linear regression models, retrieval-augmented generation (“RAG”) applications, deep learning models, supervised or unsupervised learning models, convolutional neural networks (“CNNs”), long short-term memory networks (“LSTM”), or any other suitable artificial intelligence models, frameworks, or other applications configured to perform the various functionalities described herein.

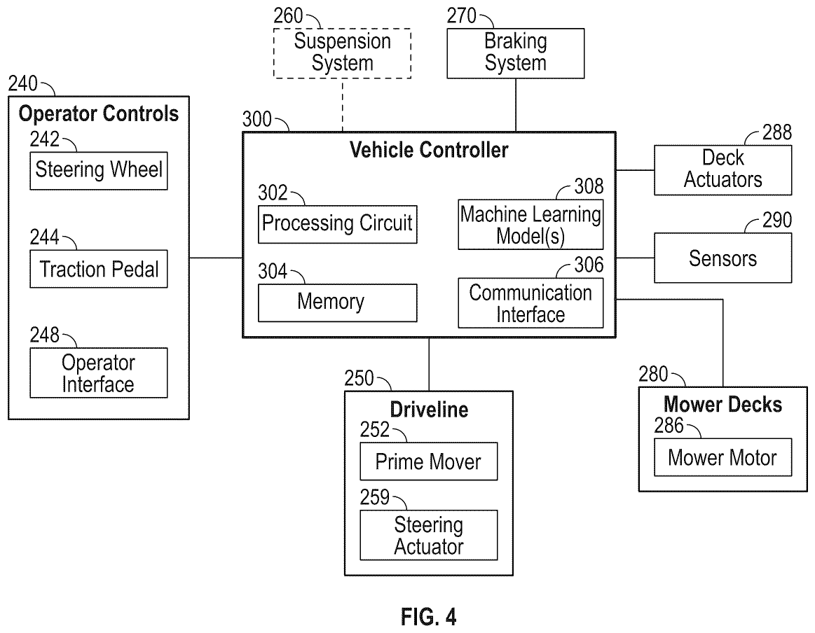

As shown in FIGS. 3A, 3B, and 4, the vehicle 10 is configured as another type of machine or vehicle (e.g., a chore product), shown as vehicle 210, including a chassis, shown as frame 212; a body assembly, shown as body 220, coupled to the frame 212 and having an occupant portion or section, shown as occupant seating area 230; operator input and output devices, shown as operator controls 240, that are disposed within the occupant seating area 230; a drivetrain, shown as driveline 250, coupled to the frame 212 and at least partially disposed under the body 220; a vehicle suspension system, shown as suspension system 260, coupled to the frame 212 and one or more components of the driveline 250; a vehicle braking system, shown as braking system 270, coupled to one or more components of the driveline 250 to facilitate selectively braking the one or more components of the driveline 250; a series of implements, mower assemblies, or cutting units, shown as mower decks 280; one or more sensors, shown as sensors 290; and a vehicle control system, shown as vehicle controller 300, coupled to the operator controls 240, the driveline 250, the suspension system 260, the braking system 270, the mower decks 280, and the sensors 290. In other embodiments, the vehicle 210 includes more or fewer components.

According to an exemplary embodiment, the vehicle 210 is an off-road machine or vehicle. As shown in FIGS. 3A and 3B, the vehicle 210 is configured as a mower (e.g., a lawnmower, a turf mower, a push mower, a ride-on mower, a stand-on mower, or another type of mower). In some embodiments, the vehicle 210 is configured as another type of chore product such as aerator, turf sprayer, bunker rake, and/or another type of chore product (e.g., that may be used on a golf course, around a business or college campus, within a municipality, etc.).

According to the exemplary embodiments shown in FIGS. 3A and 3B, the occupant seating area 230 includes a single seat, shown as driver seat 232. In some embodiments, the occupant seating area 230 includes additional seats (e.g., a passenger seat, an additional row of seats, etc.). According to the exemplary embodiments shown in FIGS. 3A and 3B, the driver seat 232 is laterally centered on the body 220 and facing forward. In some embodiments, the driver seat 232 is facing rearward or otherwise positioned. In some embodiments, the occupant seating area 230 is omitted (e.g., the vehicle 210 is configured as a push mower). A portion of the frame 212 defines a platform, deck, or standing area, shown as operator platform 234. The operator platform 234 may extend forward of the driver seat 232 such that the occupant can rest their feet on the operator platform 234 while seated in the driver seat 232. The operator platform 234 may support the occupant as the occupant enters or exits the driver seat 232.

According to an exemplary embodiment, the operator controls 240 are configured to provide an operator with the ability to control one or more functions of and/or provide commands to the vehicle 210 and the components thereof (e.g., turn on, turn off, drive, turn, brake, engage various operating modes, raise/lower a mower deck 280, etc.). As shown in FIGS. 3A, 3B, and 4, the operator controls 240 include a steering interface (e.g., a steering wheel, joystick(s), etc.), shown steering wheel 242, an accelerator interface and/or braking interface (e.g., a pedal, a throttle, etc.), shown as traction pedal 244, and one or more additional interfaces, shown as operator interface 248. The steering wheel 242 may be used by an operator to indicate a desired steering direction of the vehicle 210. The traction pedal 244 may be used to control the speed and direction of travel of the vehicle 210. By way of example, pressing the traction pedal 244 in a first direction may cause the driveline 250 to move the vehicle 210 forward, and pressing the traction pedal 244 in an opposing section direction may cause the driveline 250 to move the vehicle 210 rearward. Returning the traction pedal 244 to a middle or neutral position may cause the braking system 270 and/or the driveline 250 to slow or stop the vehicle 210 or to hold the vehicle 210 in place. Alternatively, the operator interface 248 may include a pair of handles that act as a steering interface and control the driveline 250 in a zero-turn configuration (e.g., a left joystick to control the left side of the driveline 250 and a right joystick to control a right side of the driveline 250). The operator interface 248 may be used to control operation of the mower decks 280 (e.g., changing a cutting speed of a mower deck 280, changing a cutting height of a mower deck 280, etc.). The operator interface 248 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc. In some embodiments, as shown in FIG. 3A, the operator interface 248 includes a remote communication device, shown as a removeable earpiece 249. The removeable earpiece 249 is configured to be worn by an operator of the vehicle 210 and to relay audio information, such as a microphone signal of the operators voice and/or audible conversation generated by the vehicle controller 300 (e.g., a virtual assistant) between the vehicle controller 300 and the removeable earpiece 249 (e.g., to be conveyed to the user via a speaker of the removeable earpiece 249).

According to an exemplary embodiment, the driveline 250 is configured to propel the vehicle 210. As shown in FIGS. 3A, 3B, and 4, the driveline 250 includes a primary driver, shown as prime mover 252, an energy storage device, shown as energy storage 254, a first tractive assembly (e.g., axles, wheels, tracks, differentials, etc.), shown as rear tractive assembly 256, and a second tractive assembly (e.g., axles, wheels, tracks, differentials, etc.), shown as front tractive assembly 258. In some embodiments, the driveline 250 is a conventional driveline whereby the prime mover 252 is an internal combustion engine and the energy storage 254 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 250 is an electric driveline whereby the prime mover 252 is one or more electric motors and the energy storage 254 is a battery system. In some embodiments, the driveline 250 is a fuel cell electric driveline whereby the prime mover 252 is one or more electric motors and the energy storage 254 is a fuel cell (e.g., that stores hydrogen, that produces electricity from the hydrogen, etc.). In some embodiments, the driveline 250 is a hybrid driveline whereby (i) the prime mover 252 includes an internal combustion engine and an electric motor/generator and (ii) the energy storage 254 includes a fuel tank and/or a battery system. According to the exemplary embodiments shown in FIGS. 3A and 3B, the rear tractive assembly 256 includes rear tractive elements and the front tractive assembly 258 includes front tractive elements that are configured as wheels. In some embodiments, the rear tractive elements and/or the front tractive elements are configured as tracks. In some embodiments, the driveline 250 is omitted, and the vehicle 210 is propelled by an operator (e.g., the vehicle 210 is configured as a push mower).

According to an exemplary embodiment, the prime mover 252 is configured to provide power to drive the rear tractive assembly 256 and/or the front tractive assembly 258 (e.g., to provide front-wheel drive, rear-wheel drive, four-wheel drive, and/or all-wheel drive operations). In some embodiments, the driveline 250 includes a transmission device (e.g., a gearbox, a continuous variable transmission (“CVT”), etc.) positioned between (a) the prime mover 252 and (b) the rear tractive assembly 256 and/or the front tractive assembly 258. The rear tractive assembly 256 and/or the front tractive assembly 258 may include a drive shaft, a differential, and/or an axle. In some embodiments, the rear tractive assembly 256 and/or the front tractive assembly 258 include two axles or a tandem axle arrangement. In some embodiments, the rear tractive assembly 256 and/or the front tractive assembly 258 are steerable (e.g., based on an input from the steering wheel 242 and using a steering actuator 259 that controls the orientation of one or more wheels). In some embodiments, both the rear tractive assembly 256 and the front tractive assembly 258 are fixed and not steerable (e.g., employ skid steer operations). By way of example, the driveline 250 may include a hydrostatic transmission that permits independent driving of the left and right sides of the driveline 250.

In some embodiments, the driveline 250 includes a plurality of prime movers 252. By way of example, the driveline 250 may include a first prime mover 252 that drives the rear tractive assembly 256 and a second prime mover 252 that drives the front tractive assembly 258. By way of another example, the driveline 250 may include a first prime mover 252 that drives a first one of the front tractive elements, a second prime mover 252 that drives a second one of the front tractive elements, a third prime mover 252 that drives a first one of the rear tractive elements, and/or a fourth prime mover 252 that drives a second one of the rear tractive elements. By way of still another example, the driveline 250 may include a first prime mover 252 that drives the front tractive assembly 258, a second prime mover 252 that drives a first one of the rear tractive elements, and a third prime mover 252 that drives a second one of the rear tractive elements. By way of yet another example, the driveline 250 may include a first prime mover 252 that drives the rear tractive assembly 256, a second prime mover 252 that drives a first one of the front tractive elements, and a third prime mover 252 that drives a second one of the front tractive elements.

According to an exemplary embodiment, the suspension system 260 includes one or more suspension components (e.g., shocks, dampers, springs, etc.) positioned between the frame 212 and one or more components (e.g., tractive elements, axles, etc.) of the rear tractive assembly 256 and/or the front tractive assembly 258. In some embodiments, the vehicle 210 does not include the suspension system 260.

According to an exemplary embodiment, the braking system 270 includes one or more braking components (e.g., disc brakes, drum brakes, in-board brakes, axle brakes, etc.) positioned to facilitate selectively braking one or more components of the driveline 250. In some embodiments, the one or more braking components include (i) one or more front braking components positioned to facilitate braking one or more components of the front tractive assembly 258 (e.g., the front axle, the front tractive elements, etc.) and (ii) one or more rear braking components positioned to facilitate braking one or more components of the rear tractive assembly 256 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, the driveline 250 is a hydrostatic transmission that performs braking by using hydraulic motors to oppose movement of the tractive elements.

Referring to FIGS. 3A and 3B, the vehicle 210 includes a series of mower decks 280 (e.g., cutting units). Each mower deck 280 includes a deck, housing, or enclosure, shown as housing 282, and a cutting element 284 (e.g., a blade, a flail, a reel, etc.) movably coupled to the housing 282. Specifically, the vehicle of FIG. 3A illustrates a vehicle 210 in which the mower decks 280 each include a cutting element 284 configured as a blade that rotates about a substantially vertical axis. FIG. 3B illustrates an alternative configuration in which the cutting elements 284 are configured as reels that each rotate about a substantially horizontal axis. Except as otherwise specified, the vehicle 210 of FIG. 3A may be substantially similar to the vehicle 210 of FIG. 3B. Accordingly, an description of the vehicle 210 of FIG. 3A may apply to the vehicle 210 of FIG. 3B, except as otherwise specified.

Referring to FIGS. 3A and 3B, the housing 282 may open downward to expose the cutting element 284 to vegetation below the housing 282. A motor or actuator (e.g., an electric motor, a hydraulic motor, etc.), shown as mower motor 286, is coupled to the housing 282 and drives movement (e.g., rotation, oscillation, etc.) of the cutting element 284. While driven by the mower motor 286, the cutting element 284 crushes, mulches, removes, or otherwise trims vegetation beneath the housing 282. Alternatively, the cutting element 284 may be driven by the prime mover 252 (e.g., through a power take off).

The vehicle 210 includes a series of linear actuators or height adjustment actuators, shown as deck actuators 288, each coupled to the frame 212 and to one or more of the mower decks 280. The deck actuators 288 permit control over a height of the corresponding mower deck 280 relative to the frame 212. The deck actuators 288 may set a cutting height of the mower deck 280. The cutting height represents a final height of vegetation that is trimmed by the mower deck 280. The deck actuators 288 may move the mower deck 280 to a travel position above the cutting height, in which the mower deck 280 is moved out of engagement with the vegetation and the ground surface. The travel position may be used when the vehicle 210 is traveling between job sites and/or the user does not wish to be trimming vegetation.

The sensors 290 may include various sensors positioned about the vehicle 210 to acquire vehicle information or vehicle data regarding operation of the vehicle 210, or the location thereof. The sensors 290 may include various sensors positioned about the vehicle 210 to acquire environment data regarding the environment surrounding the vehicle 210. By way of example, the sensors 290 may include an accelerometer, a gyroscope, a compass, a position sensor (e.g., a GPS sensor, an RTK sensor, etc.), an inertial measurement unit (“IMU”), suspension sensor(s), wheel sensors, an audio sensor or microphone, a camera, an optical sensor, a proximity detection sensor, linear potentiometers, an occupant sensor, and/or other sensors to facilitate acquiring vehicle information, vehicle data, or environment data regarding operation of the vehicle 210, the location thereof, and/or the surrounding environment. According to an exemplary embodiment, one or more of the sensors 290 are configured to facilitate detecting and obtaining vehicle telemetry data including position of the vehicle 210, whether the vehicle 210 is moving, travel direction of the vehicle 210, slope of the vehicle 210, speed of the vehicle 210, vibrations experienced by the vehicle 210, sounds proximate the vehicle 210, suspension travel of components of the suspension system 260, and/or other vehicle telemetry data.

As shown in FIG. 3A, the occupant seating area 230 include one or more occupant sensors, shown as occupant sensors 292, configured to detect whether an operator or passenger is seated or positioned within the occupant seating area 230. In some embodiments, one or more of the occupant sensors 292 are disposed within or underneath the driver seat 232 to facilitate detecting whether an occupant is sitting within the occupant seating area 230. In some embodiments, one or more of the occupant sensors 92 are disposed within a floorboard of the vehicle 210 to facilitate detecting whether an occupant has entered or exited the occupant seating area 230. In some embodiments, one or more of the occupant sensors 292 are cameras, proximity sensors, etc. disposed about the occupant seating area 230 and configured to facilitate detecting the presence of an occupant within the occupant seating area 230 (e.g., machine vision, etc.).

As shown in FIG. 4, the vehicle controller 300 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 4, the vehicle controller 300 includes a processing circuit 302, a memory 304, a communication interface 306, and one or more machine learning models 308. The processing circuit 302 may include an ASIC, one or more FPGAs, a DSP, circuits containing one or more processing components, circuitry for supporting a microprocessor, a group of processing components, or other suitable electronic processing components. In some embodiments, the processing circuit 302 is configured to execute computer code stored in the memory 304 to facilitate the activities described herein. The memory 304 may be any volatile or non-volatile or non-transitory computer-readable storage medium capable of storing data or computer code relating to the activities described herein. According to an exemplary embodiment, the memory 304 includes computer code modules (e.g., executable code, object code, source code, script code, machine code, etc.) configured for execution by the processing circuit 302. In some embodiments, the vehicle controller 300 represents a collection of processing devices. In such cases, the processing circuit 302 represents the collective processors of the devices, and the memory 304 represents the collective storage devices of the devices.

In one embodiment, the vehicle controller 300 is configured to selectively engage, selectively disengage, control, or otherwise communicate with components of the vehicle 210 (e.g., via the communication interface 306, a controller area network (“CAN”) bus, etc.). According to an exemplary embodiment, the vehicle controller 300 is coupled to (e.g., communicably coupled to) components of the operator controls 240 (e.g., the steering wheel 242, the traction pedal 244, the brake 246, the operator interface 248, etc.), components of the driveline 250 (e.g., the prime mover 252), components of the braking system 270, the mower decks 280, the deck actuators 288, and the sensors 290. By way of example, the vehicle controller 300 may send and receive signals (e.g., control signals, location signals, etc.) with the components of the operator controls 240, the components of the driveline 250, the components of the braking system 270, the sensors 290, and/or remote systems or devices (via the communication interface 306 as described in greater detail herein).

The communications interface 306 facilitates communications (e.g., wired or wireless communications) between the vehicle 210 and other devices (e.g., other vehicles 210, the user sensors 420, the user portal 430, the remote systems 440, etc.). By way of example, the communication interface 330 may be configured to employ one or more types of wireless communications protocols including Bluetooth, Wi-Fi, radio, cellular, internet-of-things (IoT) telemetry, and/or other suitable wireless communications protocols.

In some embodiments, the machine learning models 308 comprise one or more GAI models, LLMs, linear regression models, RAG, deep learning models, supervised or unsupervised learning models, CNNs, LSTM, or any other suitable artificial intelligence models, frameworks, or other applications configured to perform the various functionalities described herein.

### Electrified Driveline

According to the exemplary embodiment shown in FIG. 5, the driveline 50 of the vehicle 10 is configured as an electrified driveline. It should be appreciated that, while the following description is provided in reference to the driveline 50, in some embodiments, the driveline 250 of the vehicle 210 may similarly be configured as an electrified driveline, and the following description of the driveline 50 and various other components of the vehicle 10 may be similarly applicable to the driveline 250 and corresponding components of the vehicle 210.

As shown in FIG. 5, in some embodiments, (a) the prime mover 52 is configured as a three-phase, alternating current (“AC”) electric motor, shown as motor 53, including three sets of windings, shown as motor windings 55, and a first sensor, shown as motor sensor 94; (b) the energy storage 54 is configured as a battery system including a first battery pack or module, shown as battery module 57, and one or more second battery packs or modules, shown as add-on battery module(s) 59, electrically coupled to the battery module 57 in parallel; and (c) the vehicle control system 100 includes (i) a first controller, shown as motor controller 110, coupled to the motor 53 and including a second sensor, shown as motor controller sensor 114, and (ii) a second controller, shown as battery management system (“BMS”) 112, coupled to the motor controller 110 and the energy storage 54 (e.g., the battery system, the battery module 57, the add-on battery module(s) 59, etc.) and including a third sensor, shown as BMS sensor 116. In some embodiments, the motor 53 is configured as a separately excited DC motor. The motor sensor 94, the motor controller sensor 114, and/or the BMS sensor 116 may include a temperature sensor, a voltage sensor, a current sensor, a speed sensor, and/or another suitable sensor to facilitate monitoring at least one of the operational parameters (e.g., temperature, voltage, current, speed, SOC, rate of charge, rate of discharge, etc.) of the motor 53, the motor controller 110, the BMS 112, the battery module 57, and/or the add-on battery modules(s) 59. The motor controller 110 and the BMS 112 may each include a processing circuit 102, a memory 104, and a communications interface 106.

According to an exemplary embodiment, each of the battery module 57 and the add-on battery module(s) 59 of the battery system includes one or more rows and/or groups of battery cells. The BMS 112 may be configured to monitor characteristics of the rows and/or groups of battery cells and/or individual cells of the battery module 57 and the add-on battery module(s) 59 (e.g., using data acquired by the BMS sensor 116) including, but not limited to, voltage, temperature, current, and state of charge (“SOC”). The BMS 112 may also be configured to provide direct current (“DC”) power from the battery system to the motor controller 110 to power the motor 53 based on driving demands of the vehicle 10.

According to an exemplary embodiment, the motor controller 110 is configured to manage the power supplied to the motor 53. By way of example, the motor controller 110 may be configured to modulate the voltage, current, phase, and/or frequency of the power sent to the motor windings 55, which can influence the torque and speed output provided by the motor 53. In some embodiments, the motor controller 110 is configured to control a type of power, AC power or DC power, delivered to the motor 53. By way of example, the motor controller 110 may be configured to convert the type of power from DC power to AC power and/or regulate the AC power or DC power depending on the intended function of the motor 53. The motor controller 110 may include components to invert, convert, or otherwise modulate DC power and/or AC power.

As shown in FIG. 5, the energy storage 54 is configured to supply (e.g., via electrical wiring, electrical connections, etc.) DC power to the motor controller 110. In some embodiments, the DC power flows from the energy storage 54, through the BMS 112, and to the motor controller 110. The BMS 112 and the motor controller 110 may include communication interfaces (e.g., communications interfaces 106) that facilitate exchanging data related to operational status, command signals, and feedback therebetween. The BMS 112 and the add-on battery module 59 (e.g., a BMS thereof) may include communication interfaces that facilitate exchanging data related to operational status, command signals, and feedback therebetween. The add-on battery module(s) 59 is(are) configured to provide additional battery cells and increase the total energy storage capacity of the energy storage 54. As shown in FIG. 5, the battery module 57 and the add-on battery module(s) 59 are connected in parallel (e.g., via wires, connection busses, etc.) to provide for a pathway of electrical transfer. In other embodiments, the battery module 57 and the add-on battery module(s) 59 are connected in series.

According to an exemplary embodiment, the BMS 112 is configured to monitor (e.g., continuously, periodically, etc.) various parameters of the energy storage 54, including voltage, current, and temperature of each cell, rows/groups, and/or module within the energy storage 54. In some embodiments, the BMS 112 is configured to calculate or otherwise determine the SOC of the energy storage 54, the battery module 57, and/or the add-on battery module(s) 59. In some embodiments, the BMS 112 is configured to redistribute charge among the cells, rows/groups, and/or the modules to ensure an equal or substantially equal charge level throughout the energy storage 54. The BMS 112 can communicate with other systems or components or the vehicle 10 or with external devices (e.g., the remote systems 440) to report on battery status and diagnostics and/or to receive control commands.

According to an exemplary embodiment, the BMS 112 is configured to detect faults or failures in the energy storage 54 that may potentially lead to or that have caused an overcharge condition and, thereby, a thermal runaway event. By way of example, the BMS 112 may be configured to monitor the voltage of individual cells, rows/groups, or modules of the energy storage 54, and when deviations from normal voltage levels occur beyond a nominal range, the BMS 112 may determine that a fault or failure is present and that there is a potential for an overcharge condition or that there is an actual overcharge condition. In some implementations, the BMS 112 is configured to detect voltage imbalance or voltage imbalance trends. By way of another example, the BMS 112 may additionally or alternatively be configured to monitor current flows during charging and discharging of the energy storage 54 and identify unexpected fluctuations in current that may indicate that a fault or failure is present and that there is a potential for an overcharge condition or that there is an actual overcharge condition. By way of still another example, the BMS 112 may additionally or alternatively be configured to monitor the temperature of the cells, rows/groups, and/or modules of the energy storage 54 and identify anomalously high temperatures that may indicate that a fault or failure is present and that there is a potential for an overcharge condition or that there is an actual overcharge condition. It should be understood that the above example of detecting faults, failures, or overcharge conditions is provided for example purposes only and is not exhaustive. Other methods or techniques may be implemented to detect faults, failures, or overcharge conditions, which are intended to be included within the scope of the present disclosure. Additional details regarding fault detection regarding the energy storage 54 is described in greater detail herein. Further details regarding fault detection, including voltage imbalance, may be found in U.S. patent application Ser. No. 18/884,363, filed Sep. 13, 2024, which is incorporated herein by reference in its entirety.

### Fleet Monitoring and Control System

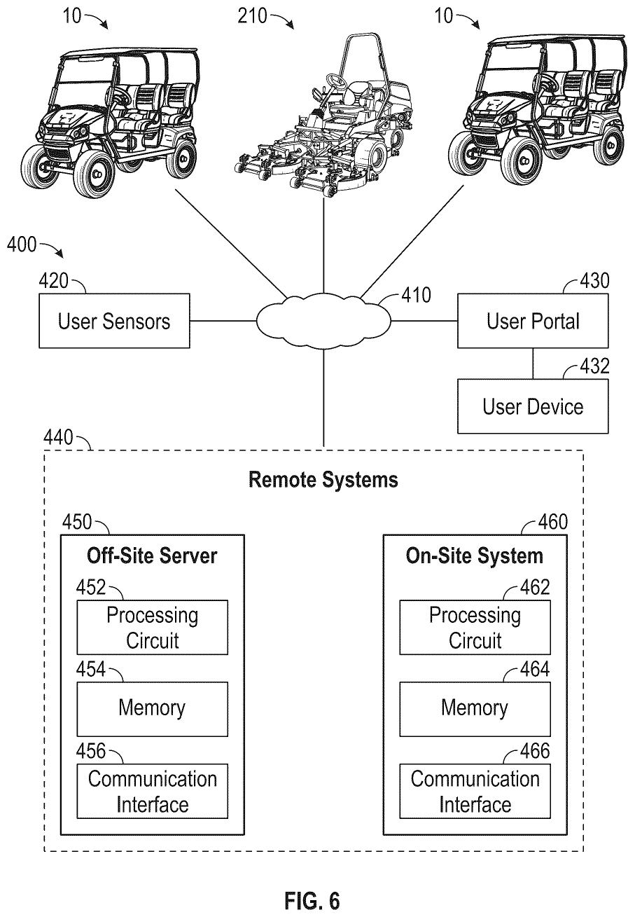

As shown in FIG. 6, a monitoring and control system, shown as fleet monitoring and control system 400, includes one or more vehicles 10 and/or vehicles 210; one or more second sensors, shown as user sensors 420, positioned remote or separate from the vehicles 10 and/or the vehicles 210; an operator interface, shown as user portal 430, positioned remote or separate from the vehicles 10 and/or the vehicles 210; an external or remote user device, shown as user device 432, positioned remote or separate from the vehicles 10 and/or the vehicles 210; and one or more external processing systems, shown as remote systems 440, positioned remote or separate from the vehicles 10 and/or the vehicles 210. The vehicles 10 and/or the vehicles 210, the user sensors 420, the user portal 430, and the remote systems 440 communicate via one or more communications protocols (e.g., Bluetooth, Wi-Fi, cellular, radio, through the Internet, etc.) through a network, shown as communications network 410 (e.g., using the communications interface 106 and/or the communication interface 306). In some embodiments, the site monitoring and control system 400 does not includes the user portal 430 and/or the user device 432.

The user sensors 420 may be or include one or more sensors that are carried by or worn by an operator of one of the vehicles 10 and/or the vehicles 210. By way of example, the user sensors 420 may be or include a wearable sensor (e.g., a smartwatch, a fitness tracker, a pedometer, a heart rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc.; location; movement; etc.) regarding the operator. In some embodiments, the user sensors 420 include the removeable earpiece 49 and/or the removeable earpiece 249 to allow for the user to verbally communicate with the vehicle 10 (e.g., the vehicle control system 100), the vehicle 210 (e.g., the vehicle controller 300), and/or any other component of the system 400 over the network 410. The user sensors 420 may communicate directly with the vehicles 10 and/or the vehicles 210, directly with the remote systems 440, and/or indirectly with the remote systems 440 (e.g., through the vehicles 10 and/or the vehicles 210) as an intermediary).

The user portal 430 may be configured to facilitate operator access to dashboards including the vehicle data, the operator data, information available at the remote systems 440, etc. to manage and operate the site (e.g., golf course, campus, project site, etc.) such as for advanced scheduling purposes, to identify persons breaking course guidelines or rules, to monitor locations of the vehicles 10 and/or vehicles 210, etc. The user portal 430 may also be configured to facilitate operator implementation of configurations and/or parameters for the vehicles 10, the vehicles 210 and/or the site (e.g., setting speed limits, setting geofences, etc.). As shown in FIG. 6, the user portal 430 is accessible via the user device 432. The user device 432 may be or include a computer, laptop, smartphone, tablet, or the like. The user portal 430 and the user device 432 may communicate via one or more communications protocols (e.g., Bluetooth, Wi-Fi, cellular, radio, through the Internet, wired connection, etc.) through a network (e.g., a CAN bus, the communications network 410, etc.). The user device 432 includes a display (e.g., a screen, etc.) configured to display one or more graphical user interfaces (“GUIs”) of the user portal 430.

As shown in FIG. 6, the remote systems 440 include a first remote system, shown as off-site server 450, and a second remote system, shown as on-site system 460 (e.g., in a clubhouse of a golf course, on the golf course, on a campus, on a work site, etc.). In some embodiments, the remote systems 440 include only one of the off-site server 450 or the on-site system 460. As shown in FIG. 6, (a) the off-site server 450 includes a processing circuit 452, a memory 454, and a communications interface 456 and (b) the on-site system 460 includes a processing circuit 462, a memory 464, and a communications interface 466.

According to an exemplary embodiment, the remote systems 440 (e.g., the off-site server 450 and/or the on-site system 460) are configured to communicate with the vehicles 10, the vehicles 210, and/or the user sensors 420 via the communications network 410. By way of example, the remote systems 440 may receive the vehicle data from the vehicles 10 and/or the vehicles 210 and/or the operator data from the user sensors 420. The remote systems 440 may be configured to perform back-end processing of the vehicle data and/or the operator data. The remote systems 440 may be configured to monitor various global positioning system (“GPS”) information and/or real-time kinematics (“RTK”) information (e.g., position/location, speed, direction of travel, geofence related information, etc.) regarding the vehicles 10, the vehicles 210, and/or the user sensors 420. The remote systems 440 may be configured to transmit information, data, commands, and/or instructions to the vehicles 10 and/or vehicles 210. By way of example, the remote systems 440 may be configured to transmit GPS data and/or RTK data based on the GPS information and/or RTK information to the vehicles 10 and/or vehicles 210 (e.g., which the vehicle control systems 100 and/or the vehicle controllers 300 may use to make control decisions). By way of another example, the remote systems 440 may send commands or instructions to the vehicles 10 and/or vehicles 210 to implement.

According to an exemplary embodiment, the remote systems 440 (e.g., the off-site server 450 and/or the on-site system 460) are configured to communicate with the user portal 430 via the communications network 410. By way of example, the user portal 430 may facilitate (a) accessing the remote systems 440 to access data regarding the vehicles 10, the vehicles 210, and/or the operators thereof and/or (b) configuring or setting operating parameters for the vehicles 10 and/or vehicles 210 (e.g., geofences, speed limits, times of use, permitted operators, etc.). Such operating parameters may be propagated to the vehicles 10 and/or vehicles 210 by the remote systems 440 (e.g., as updates to settings) and/or used for real time control of the vehicles 10 and/or vehicles 210 by the remote systems 440.

In some embodiments, the remote systems 440 (e.g., the off-site server 450 and/or the on-site system 460) may further include one or more third-party systems associated with an entity that owns, rents, leases, or otherwise manages a fleet of vehicles (e.g., vehicles 10 or vehicles 210). For example, in some instances, a company or other enterprise may purchase, rent, lease, or otherwise utilize a plurality of vehicles for performing various tasks associated with the company or enterprise (e.g., maintenance, security, landscaping, etc.), as will be described further herein. In these instances, the remote systems 440 may comprise one or more external, remote, and/or cloud-based servers configured to provide various information, applications, and/or various other functionality to be utilized by the vehicle 10 and/or the vehicle 210 to perform the various functionalities described herein.

### Vehicle Dock Interface

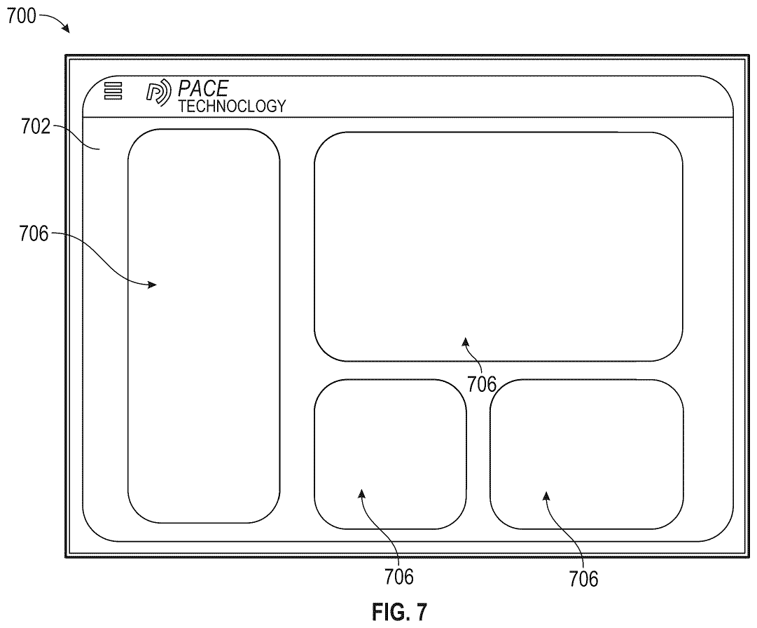

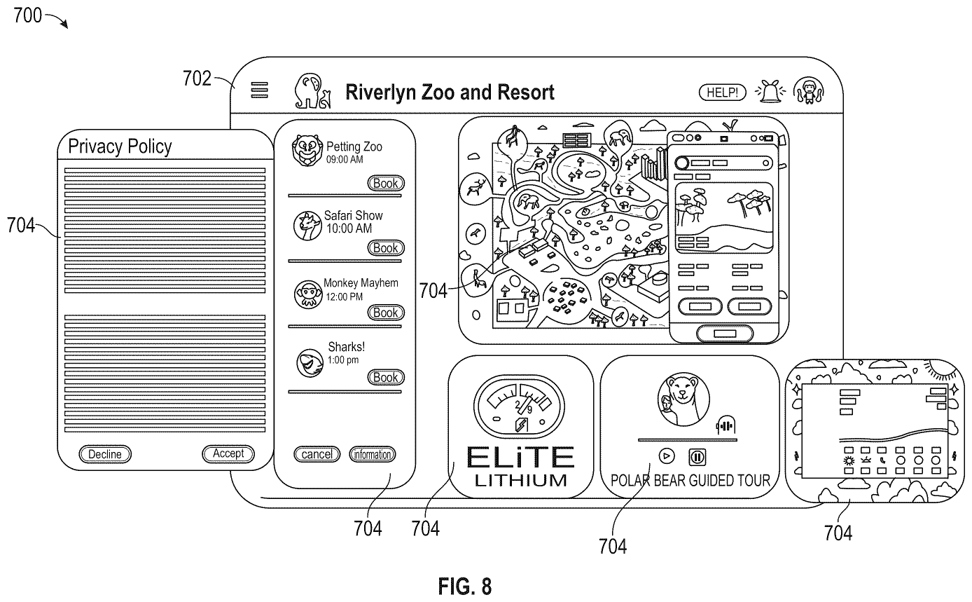

As shown in FIGS. 7 and 8, a vehicle dock interface, shown as dock interface 700, includes a dock framework, shown as framework 702, configured to have one or more application widgets, shown as application widgets 704, installed or otherwise implemented therein within corresponding application widget frames, shown as widget frames 706. The dock interface 700 may be displayed to a user via an operator interface of a vehicle (e.g., the operator interface 48 and/or the operator interface 248) and may be customizable to accommodate a variety of layouts including application widgets 704 of varying size having various functionalities associated therewith. The dock interface 700, the framework 702, the application widgets 704, and/or the applications associated with the application widgets 704 may be programmed, developed, or otherwise written in JavaScript, React, and/or any other suitable application programming language, framework, or protocol.

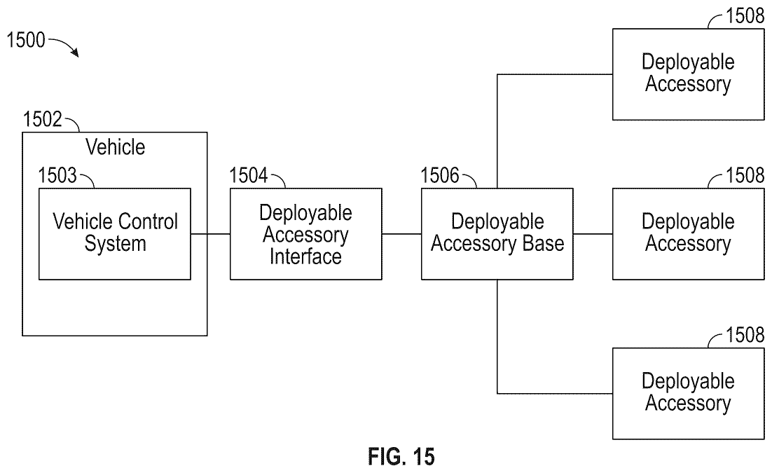

The dock interface 700 is configured to provide a robust, modular application framework designed to integrate and expose data and functions of various vehicle systems (e.g., the operator controls 40, the driveline 50, the suspension system 60, the braking system 70, the sensors 90, the vehicle control system 100, drive-by-wire systems, telemetry systems, etc.), remote systems (e.g., the remote systems 440, third-party accessory networks, other resources and systems accessible via the internet), and/or other third-party components (e.g., the deployable accessories 1508 shown in FIGS. 15-17) to a vehicle operator. That is, the dock interface 700 provides a central dock application that may be stored on the vehicle control system 100 and/or the vehicle control system 300 (e.g., which may be or comprise an edge computer on the vehicle 10 or the vehicle 210) and may act as a type of browser for hosting and organizing various applications (e.g., the applications associated with the application widgets 704) developed by an original equipment manufacturer (“OEM”) associated with the vehicle 10, the vehicle 210, and/or third parties within the framework 702. Beneficially, the dock interface 700 allows for the selective integration of vehicle information and functionality with third party information and functionality within OEM and third-party developed applications, as will be described herein.

As shown in FIG. 8, the framework 702, the application widgets 704, and/or the applications associated with the application widgets 704 may be customized to include various information and/or functionalities associated with the vehicle 10, the vehicle 210, and/or a party (e.g., a third party entity) that owns, rents, or is otherwise utilizing the vehicle 10 and/or the vehicle 210. For example, in some instances, the application widgets 704 may include various widgets, pop-ups, modals, etc., such as a map widget (e.g., showing a map showing the real-time location of the vehicle 10), a scheduling widget (e.g., allowing a user to schedule various activities), an informational widget (e.g., providing information pertaining to areas or events happening at a site), a weather widget (e.g., providing local weather information), a corporate information widgets (e.g., including privacy notifications, expressing safety requirements, and/or other information associated with a business or entity), a battery charge level widget (e.g., showing a real-time battery charge level of a battery of the vehicle 10), a speed widget (e.g., showing a real-time speed of the vehicle 10), and/or any other application described herein or developed for implementation within the dock interface 700.

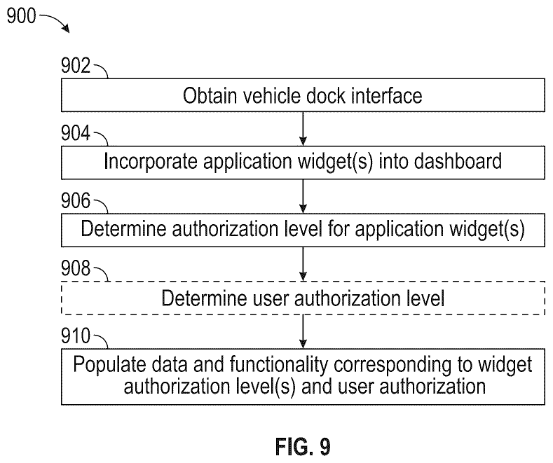

Referring now to FIG. 9, a method 900 for generating and populating a vehicle dock interface (e.g., the vehicle dock interface 700) is provided below. It should be appreciated that the following description is provided as an example and is in no way meant to be limiting. Furthermore, it should be appreciated that, in some embodiments, various steps may be added, omitted, and/or rearranged within the method 900 without departing from the scope of the present disclosure.

In some embodiments, the method 900 begins with the vehicle control system 100 obtaining the dock interface 700, at step 902. For example, in some instances, the dock interface 700 is initially programmed into the vehicle control system 100 by the OEM and stored within the memory 104 during manufacturing of the vehicle 10. In some other instances, the vehicle control system 100 receives the dock interface 700 from an external device, such as the remote systems 440 or the user device 432. In some embodiments, the dock interface 700 may initially include only the framework 702 or the framework 702 and one or more default OEM-provided applications associated with OEM-provided application widgets 704.

In some embodiments, the vehicle control system 100 then incorporates the application widgets 704 into the framework 702, at step 904. For example, the dock interface 700 is configured to allow for the application widgets 704 to be added and placed within the framework 702 (e.g., within corresponding widget frames 706). The dock interface 700 is further configured to allow for the application widgets 704 to selectively control and/or communicate with various components of the vehicle 10. The dock interface 700 is further configured to allow for the application widgets 704 to utilize and communicate with various third-party systems (e.g., remote systems 440, other resources on the internet) via the communication network 410.

In some embodiments, the application widgets 704 and the corresponding applications are uploaded to the vehicle control system 100 (e.g., via a wired connection or the communications network 410) from one of the remote systems 440, the user device 432, and/or any other device or computer system where the application widgets 704 and the corresponding applications were developed via a wired or wireless connection (e.g., via the communications network 410). The application widgets 704 and the corresponding applications may then be stored on the vehicle control system 100 within the memory 104 (e.g., as part of the dock interface 700). In some embodiments, one or more of the application widgets 704 and the corresponding applications may additionally or alternatively be hosted on an external server (e.g., one of the remote systems 440) and accessed by the dock interface 700 via the communications network 410. For example, a third party may upload one or more application widgets 704 and corresponding applications to one of the remote systems 440, and the dock interface 700 may provide remote access to the application widgets 704 and corresponding applications via the communications network 410.

Each of the application widgets 704 and the corresponding applications may be programmed or otherwise developed to selectively access a variety of information from the vehicle 10 and/or various remote systems (e.g., the remote systems 440 and/or other resources via the internet). For example, in some instances, the dock interface 700 is configured to translate hypertext transfer protocol (“HTTP”) communications, application programming interface (“API”) calls, and/or any other suitable programming language associated with each application widget 704 to robot operating system (“ROS”) programming language and vice versa to allow for application widgets 704 having appropriate authorization, as will be further described below, to selectively interface with, control, and/or otherwise obtain information from various components of the vehicle 10 via the communications interface 106 (e.g., which may act as a ROS interface with the various components of the vehicle 10).

In some embodiments, the application widgets 704 and the corresponding applications are developed, programmed, or otherwise created by the OEM that manufactured the vehicle 10 and/or by one or more third parties. For example, the OEM may develop one or more application widgets 704 and corresponding applications that may access various information associated with and functionalities of the vehicle 10 (e.g., telematics information, vehicle control operations), as will be further discussed below. Additionally, various third parties may develop their own application widgets 704 and corresponding applications that may incorporate information from the third parties'own third-party systems (e.g., one or more of the remote systems 440), as well as various information associated with and functionalities of the vehicle 10.

In some embodiments, the vehicle control system 100 then determines an authorization level for each application widget 704 and corresponding application, at step 906. For example, the dock interface 700 may include application widgets 704 having varying levels of security and/or data access. In some instances, one or more of the application widgets 704 and corresponding applications include authorization keys (e.g., API keys) that indicate different authorization levels for accessing information and/or functionalities from the vehicle 10 and/or a remote system (e.g., one of the remote systems 440). Accordingly, the dock interface 700 may abstract and selectively expose various vehicle data and/or functionality control for the vehicle 10 to the various application widgets 704 and corresponding applications based on each application's corresponding authenticated local API.

For example, various authorization keys may provide access to different functionalities of the vehicle 10, such as starting the vehicle 10, stopping the vehicle 10, locking the vehicle 10, unlocking the vehicle 10, utilizing machine-learning algorithms (e.g., one or more machine learning models 108) stored on the vehicle control system 100 (e.g., for detecting object/people, artificial intelligence based virtual assistants, etc.), access to the internet and/or other communications networks (e.g., via the communications interface 106), and/or various other functionalities of the vehicle 10 described herein (e.g., utilization of any of the various applications described herein). Various authorization keys may additionally or alternatively provide access to different levels of vehicle information access associated with the vehicle 10, such as access to view onboard telemetry of the vehicle 10 (e.g., vehicle speed, vehicle location, state of charge) and/or any other vehicle information. Similarly, various third-party managed authorization keys may provide access to corresponding third-party backend systems, such as human resource systems, facilities integration systems, work order tracking systems, work management systems, customer experience systems (e.g., associated with tourism locations), and/or any other desired third-party information and/or functionalities.

In some instances, authorization keys associated with accessing vehicle information and/or functionalities associated with the vehicle 10, as well as their corresponding access levels, are managed by the OEM of the vehicle 10 (e.g., via a corresponding remote system 440). For example, in some instances, the OEM may allow for third parties to subscribe (e.g., for any number of vehicles) to varying levels of vehicle data and/or functionality access for their developed applications. In some instances, the OEM may only provide a select subset of vehicle data and functionality access to third parties, such that some vehicle data and/or functionalities are only available to OEM-developed applications (e.g., having specific OEM authorization keys). Additionally, in some instances, certain application widgets 704 and corresponding applications may have access to more or less vehicle information and/or functionalities than others. Authorization keys associated with accessing third-party information and/or functionalities associated with various third-party systems may be managed by corresponding third parties (e.g., via another corresponding remote system 440) in a similar manner.

As an example, different authorization keys may allow for different secure exposure of data and functions of the vehicle 10 and/or various third-party systems via corresponding APIs, isolated docker containers, and/or any other suitable data segmentation and/or securitization methods. For example, third-party developed applications may have programming language that includes various vehicle data access and/or functionality calls. Upon running that programming language, the dock interface 700 may automatically perform an authorization check using the application's authorization key(s) prior to allowing for access to the corresponding vehicle data and/or functionality. For example, the dock interface 700 may transmit an authorization request to the system managing the corresponding authorization key (e.g., a remote system 440 associated with the OEM or a third party), and the system managing the corresponding authorization key may provide the dock interface 700 with an indication of the authorization level of the application widget 704.

In some embodiments, the vehicle control system 100 then determines a user authorization level for the user, at step 908. For example, in some instances, one or more of the application widgets 704 and corresponding applications may require the operator of the vehicle 10 to authenticate themselves to ensure that the user is authorized to access information or functionalities associated with the corresponding application and/or is credentialed to operate the vehicle 10. Accordingly, the dock interface 700 may require that the operator to be authenticated and verified as authorized to access various information and/or functionality of the application widgets 704 and corresponding applications and/or to access the dock interface 700 generally. In some embodiments, the application widgets 704 and corresponding applications are configured to selectively access remote HR systems to authenticate a given operator and to determine whether the operator is authorized to access various vehicle data and/or functionalities, and/or various third-party information associated with a third-party entity.

For example, in some instances, the dock interface 700 (and/or any of the applications thereon) is configured to allow the operator of the vehicle 10 authenticate themselves via a password, facial or vocal recognition or other biometric (e.g., via a camera on the user device 432 and/or one or more sensors 90 on the vehicle 10), via a badge scan (e.g., via a badge scan or other near-field communication with one of the sensors 90 and/or the communications interface 106). In some instances, various applications widgets 704 and corresponding applications may have passthrough authentication and authorization (e.g., no authentication or authorization required). For example, if the vehicle 10 has been turned on (e.g., using a key), the user may not need to do any additional authentication to access the dock interface 700 and/or various application widgets 704 and corresponding applications. In some instances, the operator is required to authenticate themselves before they are allowed to start the vehicle 10.

In some embodiments, once the dock interface 700 determines the authorization level for each of the application widgets 704 and corresponding applications and determines the user authorization level, at steps 906 and 908, the vehicle control system 100 then populates the framework 702 and application widgets 704 with the appropriate data and functionality, at step 910. For example, as described above, the dock interface 700 has access to all the vehicle data and functionalities via the communications interface 106 of the vehicle control system 100, and can thus provide access to the various vehicle information and/or functionalities to the appropriate application widgets 704 and corresponding applications. Similarly, the application widgets 704 and corresponding applications may access the appropriate third-party information and/or functionalities from any applicable third party systems (e.g., via the communications network 410).

Accordingly, the dock interface 700 beneficially allows for the integration of information and functionalities of the vehicle 10, OEM remote systems, and/or third-party systems within various OEM and/or third-party developed applications. Additionally, third-party developers may develop their own applications for the dock interface 700 that interface with their own systems, as well as those of the vehicle 10, without direct involvement from the OEM in the application development process.

While the descriptions of the dock interface 700 and the method 900 for generating and populating the dock interface 700 provided above refer predominantly to the vehicle 10 and its components, it should be appreciated that the dock interface 700 may be generated and populated in a similar manner and may be similarly displayed on or otherwise implemented within the vehicle 210, and that the descriptions above may be similarly applicable to the vehicle 210 and its components.

### Enterprise Workflow Management Application

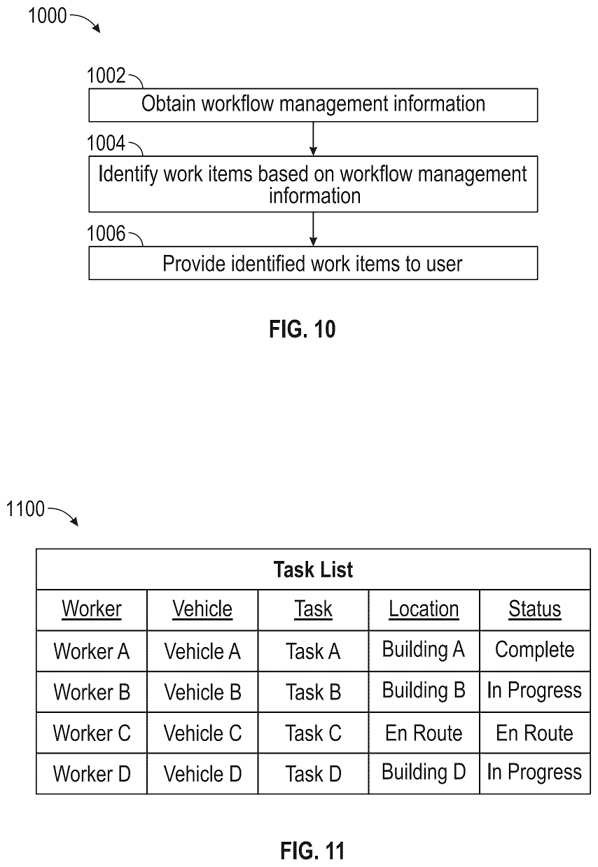

Referring now to FIG. 10, a method 1000 for managing an enterprise workflow is provided below. It should be appreciated that the following description is provided as an example and is in no way meant to be limiting. Furthermore, it should be appreciated that, in some embodiments, various steps may be added, omitted, and/or rearranged within the method 1000 without departing from the scope of the present disclosure.

In some embodiments, the method 1000 is performed by one of the remote systems 440 (e.g., one of the off-site servers 450 and/or one of the on-site systems 460) using a machine learning application similar to one of the machine learning models 108 and stored in the corresponding memory 454 and/or memory 464. In some embodiments, the method 1000 is performed by a machine learning application (e.g., one of the machine learning models 108) stored on the vehicle control system 100. For clarity, the term “workflow management application” is used herein to refer to the machine learning application that performs the method 1000. It should be understood that the workflow management application may be performed by at least one of the remote systems 440 or the vehicle control system 100 (or the vehicle controller 300).

In some instances, the workflow management application is an application associated with an application widget 704 displayed on the dock interface 700. In some other instances, the workflow management application is a standalone application that may be selectively accessed and utilized by third-party applications uploaded to the dock interface 700 to enable enterprise workflow management, as described herein. In either case, the workflow management application is configured to selectively access any of the various information accessible by the dock interface 700, the application widgets 704, and/or their corresponding applications in a similar manner to that discussed above with respect to the description of FIGS. 7-9.

As shown in FIG. 10, the method 1000 begins with obtaining various workflow management information and/or functionality pertaining to a third party's enterprise, at step 1002. For example, in some instances, to effectively utilize the workflow management application, a third-party system (e.g., another one of the remote systems 440) may provide a variety of information and/or functionality to be used by the workflow management application when performing the various workflow management steps below.

For example, in some instances, the third-party system may provide a variety of employee information (e.g., employee credential and/or skill information, employee schedule information, etc.), task information (e.g., a list of tasks for performance by employees, task locations, priority levels of tasks, expected task duration, tools required for a given task, employee credentials or skills required for a given task, task performance instructions, etc.), enterprise site information (e.g., building information model (“BIM”) data associated with an enterprise site, site maps, campus maps, building floorplans, other map information associated with an enterprise site, etc.), etc. In some instances, the third-party system may additionally provide access to various functionality provided by the third-party system (e.g., access to scheduling applications, access to human resource systems and applications, access to communication applications, etc.).

In some instances, the vehicle control system 100 may additionally obtain various real-time information pertaining to the vehicle 10 (e.g., location information, telematics information, onboard tool information (e.g., determined via one or more sensors 90 configured to detect and/or cameras configured to view what tools are onboard the vehicle 10 and/or charge levels associated with those tools), battery charge state, speed, movement direction, etc.) and provide the real-time information to the workflow management application. It should be appreciated that secure access to the information and/or the functionalities of the third-party system and/or the vehicle 10 (e.g., via secure API calls and/or corresponding isolated docker containers) may be selectively enabled based on authorization keys, as described above, with respect to the dock interface 700. In some instances, the remote system 440 and/or the vehicle control system 100 may obtain various additional information from publicly available resources (e.g., a map of a relevant area pulled from Google Maps®).

Additionally, in some instances, the vehicle control system 100 additionally identifies the operator of the vehicle 10 (e.g., via any of the identification methods discussed herein) and additionally provide an identity of the operator of the vehicle 10 to the workflow management application (e.g., to be utilized by the workflow management application in determining the operator's credentials and/or skills when determining which operators and vehicles should perform which work items).

Once the workflow management application has obtained the various workflow management information pertaining to a third party's enterprise, at step 1002, the workflow management application then identifies work items for various employees or other users, at step 1004. For example, in some instances, the workflow management application is trained using a variety of structured and/or unstructured training data to prioritize work items for a plurality of users based on changing variables, such as task duration for each work item, each employee's time left on a work shift, each employee's distance from a given task (e.g., determined via map information and GPS data associated with the vehicle 10), skills required for a given task, tools required for a given task, the state of charge of each employee's vehicle, etc.

In some instances, the training data used to train the workflow management application may include historical information similar to the workflow management information discussed above and correlated with various task lists and prioritizations corresponding to different goals and requirements (e.g., performing all tasks in the shortest amount of time, requiring that employees do not work overtime, ensuring that employees have the appropriate tools and credentials, etc.). In some instances, the training data may include various additional information, such as vehicle manuals associated with different vehicles used by the third party, tool manuals associated with various tools that may be utilized for different work items, troubleshooting guides, etc., which may be used by the machine learning algorithm to infer various information pertaining to tasks and/or prioritizations. In some instances, the workflow management application may be continuously trained on an ongoing basis using received feedback (e.g., additional workflow management information correlated to new tasks, updated task duration information, updated employee information, updated task information, additional prioritization information, etc.).

Accordingly, the training data may be used to train the workflow management application, and the workflow management application can then be used to prioritize work items to be performed within a given area (e.g., a campus, a work site, a golf course, etc.) of an enterprise based on the obtained workflow management information (e.g., optimizing or otherwise prioritizing what tasks are to be completed by which employees and vehicles, how each employee should go about completing their tasks, etc.).

In some instances, the workflow management application may track or otherwise monitor work item progress for each employee, as will be described further below, and may be configured to continuously update and/or continuously prioritize work items on a real-time or near real-time basis for a plurality of employees throughout a given work period. For example, in some instances, the workflow management application may monitor how long employees have been working on their respective tasks, how long each task is expected to take, where each employee is within the campus or worksite (e.g., based on GPS information from the employee's vehicle or user device), what skills and/or credentials each employee has, what tools each employee has available to them (as well as how charged those tools are), and how much time each employee has left in their respective shift, and may automatically assign and/or reassign tasks as necessary throughout a work period to ensure that each necessary work item is completed.

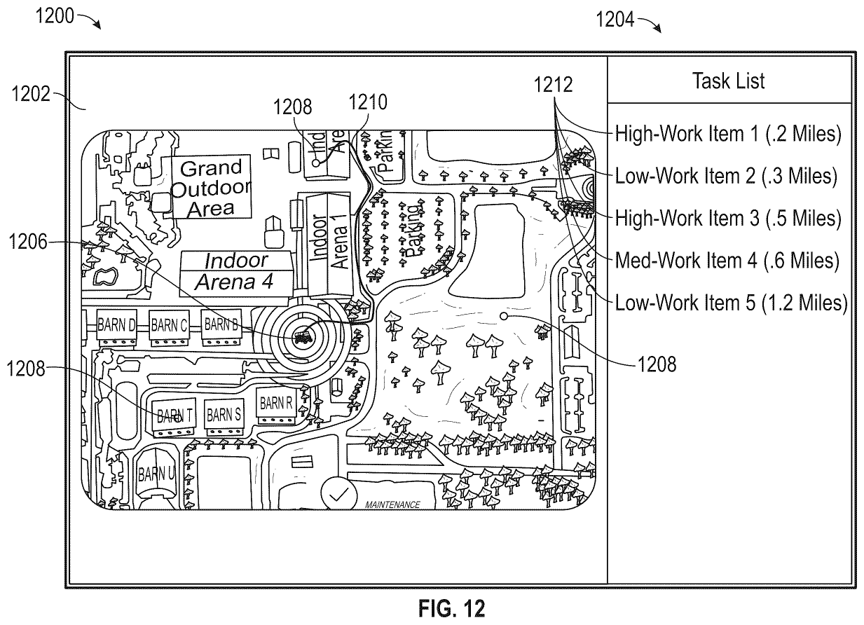

Accordingly, the workflow management application is configured to prioritize and identify various work items for each employee to potentially perform based on the obtained workflow management information discussed above. Once the workflow management application has identified the various work items for potential performance by each employee, at step 1004, the workflow management application then provides the identified work items to each employee, at step 1006. For example, in some instances, the workflow management application may transmit a notification including the next work item to be performed by the worker to the vehicle control system 100 to be displayed to the operator. In some instances, the notification may include an interactive map showing how to get to a location of the next work item and various other information via an interactive user interface (e.g., the dynamic work interface 1200 shown in FIG. 12 and described below).

As shown in FIG. 11, a work management interface 1100 includes a list of workers, vehicles, tasks, locations, and task statuses. In some instances, the work management interface 1100 is generated, provided, and updated via the workflow management application discussed above and may displayed to the operator of the vehicle 10 via an application widget 704 accessible via the dock interface 700. Accordingly, a manager riding in a vehicle (e.g., the vehicle 10) may view where different workers are, what tasks they are working on, and what the status of those tasks are. In some other instances, the work management interface 1100 is provided via another interface displayed to the operator of the vehicle 10 (e.g., via the operator interface 48) or to a manager associated with a third-party system (e.g., via a display of one of the remote systems 440.

### Dynamic Vehicle-Based Work Application With Virtual Assistant

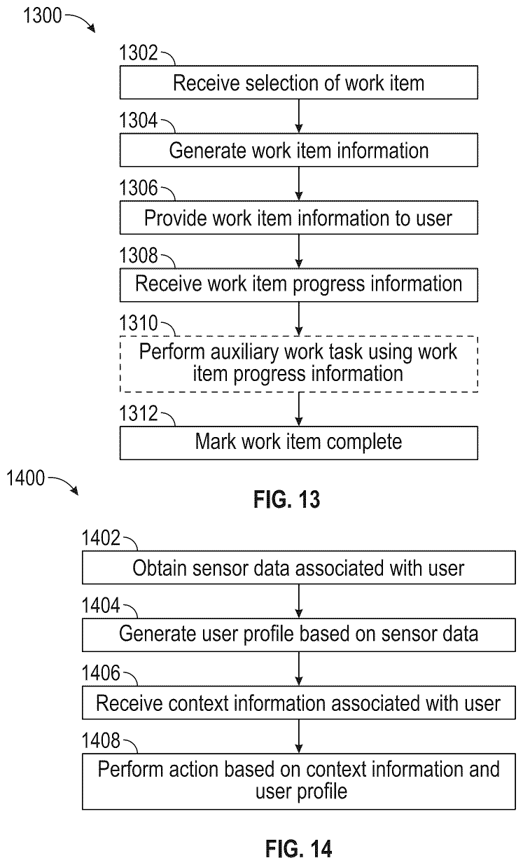

Referring now to FIG. 12, a dynamic work interface 1200 includes a map graphic, shown as map graphic 1202, and a work item list graphic, shown as work item list 1204. In some instances, the dynamic work interface 1200 is provided via a separate machine learning application (e.g., one of the machine learning models 108) stored on the vehicle control system 100 that is configured to interface with the work management application discussed above. For clarity, the term “dynamic work application” is used herein to refer to the machine learning application utilized to generate the dynamic work interface 1200 and to perform the method 1300 discussed below, with reference to FIG. 13. However, it should be appreciated that, in some instances, the functionalities of the work management application discussed above and the dynamic work application discussed below may be provided by a single machine-learning-based application.

In some instances, the dynamic work application is similarly an application associated with an application widget 704 displayed on the dock interface 700. In some other instances, the dynamic work application is a standalone application that may be selectively accessed and utilized by third-party applications uploaded to the dock interface 700 to enable dynamic work item selection and interactive monitoring, as described herein. In either case, the dynamic work application is configured to selectively access any of the various information accessible by the dock interface 700, the application widgets 704, and/or their corresponding applications in a similar manner to that discussed above with respect to the description of FIGS. 7-9.

As shown in FIG. 12, the map graphic 1202 depicts a map showing a vehicle icon 1206, a plurality of work item location icons 1208, and a navigation path 1210. In some embodiments, the plurality of work item location icons 1208 are each selectable on the map graphic 1202 to select a corresponding work item for performance. The work item list 1204 additionally includes a plurality of selectable work items 1212 that may be selectable within the work item list 1204 to select a corresponding work item for performance. As illustrated, in some instances, each work item includes an indication of a priority of the work item (e.g., high, medium, low), as well as a distance between the vehicle 10 and the work item location. As will be described further below, in some embodiments, upon selection of a given work item (e.g., via selection of one of the work item location icons 1208 or one of the selectable work items 1212), the dynamic work application generates and adds the navigation path 1210 to the map graphic 1202 to provide directions between where the vehicle 10 is currently located and a location of the work item to be performed. In some instances, the dynamic work application may additionally provide an estimated time to arrival for reaching the work item location (e.g., based on GPS data associated with the vehicle 10, a distance between the vehicle 10 and the work item location, an expected speed of the vehicle 10 along the navigation path 1210, a heading of the vehicle 10, etc.).

Referring now to FIG. 13, a method 1300 for enabling and interactively monitoring various work items is provided below. As discussed above, in some embodiments, the method 1300 is performed by the dynamic work application running on the vehicle control system 100. It should be appreciated that the following description is provided as an example and is in no way meant to be limiting. Furthermore, it should be appreciated that, in some embodiments, various steps may be added, omitted, and/or rearranged within the method 1300 without departing from the scope of the present disclosure.

The method 1300 begins with the dynamic work application receiving a selection of a work item, at step 1302. For example, as discussed above, in some instances, the workflow management application may provide a list of potential work items for the worker to select from based on a predetermined prioritization conducted by the workflow management application. In some embodiments, the dynamic work application may simply receive various work items and corresponding work item information (e.g., location, duration, requirements, etc.) from a third-party system, and may generate a list of nearby work items for selection by the worker.

In some instances, the dynamic work application may receive the selection of the work item via the dynamic work interface 1200 (e.g., via selection of one of the work item location icons 1208 or one of the selectable work items 1212). In some instances, the dynamic work application may receive the selection of the work item via the workflow management application described with reference to FIGS. 10 and 11. In some embodiments, the dynamic work application may receive the selection of the work item via a verbal indication received from the operator (e.g., the worker) of the vehicle 10 (e.g., captured via one of the sensors 90).

For example, as referenced above, the various machine learning models 108 (e.g., the dynamic work application, the workflow management application) may comprise GAI models, LLMs, and/or any other suitable machine learning models configured to allow for speech recognition and/or language generation to provide a voice-based or text-based chat-bot or virtual assistant configured to interact with the operator of the vehicle 10. In some instances, the same machine learning model 108 may provide both the functionalities of the dynamic work application and the conversational capabilities described herein. In some instances, the dynamic work application may include multiple machine learning models configured to interface with one another to provide both the functionalities of the dynamic work application and the conversational capabilities described herein.

Accordingly, as an example, the worker may verbally ask the dynamic work application a question regarding nearby work items (e.g., “what kind of work items are nearby?”), the dynamic work application can provide options for nearby work items for selections (e.g., “you have two work items within a 5 minute drive”), and the worker can verbally select one of the work items (e.g., “alright, let's go with the first item”).

Upon receiving the selection of the work item, at step 1302, the dynamic work application generates various work item information associated with the selected work item, at step 1304, and provides the work item information to the operator of the vehicle 10, at step 1306. For example, in some instances, the dynamic work application may provide various instructions for performing the corresponding work item (e.g., via a notification displayed on the dynamic work interface 1200 or via an audible virtual assistant message).

For example, as discussed above, each of the potential work items may be displayed via corresponding work item location icons 1208 on the map graphic 1202. Upon selection of a particular work item, the dynamic work application may automatically update the map graphic 1202 to include the navigation path 1210 showing how to get from the current location of the vehicle 10 to the location of the selected work item (e.g., which may be obtained as part of the work management information discussed above).

In some instances, the dynamic work application may provide a variety of interactive mapping functionalities. For example, in some instances, the dynamic work application is configured to identify, based on obtained map and/or building information (e.g., BIM data, MAT data) associated with a work site or campus, the most efficient route from the vehicle 10 to the location both exterior to any buildings (e.g., within drivable areas), as well as within any relevant buildings or other facilities as well. Accordingly, in some instances, the navigation path 1210 generated by the dynamic work application shows outdoor directions to be traveled by the vehicle 10, parking locations where the vehicle 10 should be parked, and/or indoor directions through a building to a particular indoor work item location.

Additionally, in some embodiments, the dynamic work application is configured to identify any potential obstacles or items of interest along the routes or otherwise associated with the work item. As an example, the dynamic work application may determine that there are various access credentials required (e.g., security badge access) for entering a particular area of a building. In some instances, the dynamic work application is configured to automatically interface with third-party systems to request and obtain the necessary access credentials for the operator of the vehicle 10 (e.g., by filling out various request documentation with one or more third-party systems). In some instances, the dynamic work application may first prompt the worker to determine whether they wish to request the relevant access credentials prior to requesting and obtaining the necessary access credentials.

For example, in some instances, upon starting the vehicle 10 and/or beginning to utilize the dock interface 700, the operator of the vehicle 10 may provide various identifying information (e.g., username, password, biometrics, etc.), which may be utilized by the dynamic work application to both identify the operator's access credentials (e.g., via communication with a third-party HR system) and to obtain necessary information needed to request additional access credentials for the operator. In some instances, the operator is automatically identified based on their voice and/or other biometric information without having to provide specific access credentials, as will be described further below with respect to FIG. 14.

As another example, the dynamic work application may be configured to identify various safety concerns along a given route toward the selected work item. For example, the dynamic work application may determine (e.g., based on BIM data and/or various additional information pulled from one or more third-party systems) that personal protection equipment (“PPE”) is required within a certain area along the identified route. The dynamic work application may similarly determine (e.g., based on received reports from other employees or other publicly available resources) that a dangerous situation is occurring along the route toward the selected work item.

In some embodiments, the dynamic work application is configured to automatically update the map graphic 1202 to show the various security access points, the areas with safety concerns, and/or related instructions (e.g., “you will need your PPE for this work item”) to the operator. For example, the dynamic work application may be configured to automatically generate geofences and georeferenced locations to be incorporated within the map graphic 1202 based on various map, building, facility, campus, etc., data received from the enterprise that owns or operates the vehicle 10 and/or various third-party mapping systems (Google Maps®).

In some embodiments, the dynamic work application may similarly automatically create one or more geofences to be used to track when the operator beings and ends the work item. For example, the dynamic work application may create a geofence around the location of the vehicle 10 (e.g., around the vehicle icon 1206) and around the work item location (e.g., around the corresponding work item location icon 1208). In some instances, the dynamic work application is configured to create the one or more geofences automatically and without a person manually setting the geofence area. For example, in some instances, the dynamic work application can be trained using a variety of structured and/or unstructured training data to automatically create geofences associated with selected work items based on a given work item's location, surrounding structures, and/or other geographical obstacles around or near the work item's location.

In some instances, the training data used to train the dynamic work application may include historical information associated with selected work item locations, information pertaining to those work items'locations and surroundings, and corresponding created geofences. In some instances, the dynamic work application may be continuously trained on an ongoing basis using received feedback (e.g., manually created geofences, modifications made to autonomously created geofences, etc.).

In some instances, the dynamic work application may additionally allow for users (e.g., the operator of the vehicle 10) to create and/or modify created geofences manually (e.g., by interacting with and indicating various points or drawing a geofence on the map graphic 1202 of the dynamic work interface 1200). In some instances, the dynamic work application may communicate the created geofences to and/or receive created geofences from various other systems (e.g., the remote system 440) and/or applications (e.g., the workflow management application).

In some embodiments, if a particular obstacle associated with a created geofence or otherwise related to a work item must be avoided (e.g., a particular access credential cannot be obtained, the vehicle 10 and/or operator does not have the necessary PPE, a safety concern needs to be avoided generally), the dynamic work application may automatically update the navigation path 1210 if possible and/or require the operator to select a new work item.

It should be appreciated that, in some embodiments, any of the interactive mapping features discussed above, with respect to the dynamic work application, may similarly be performed by the workflow management application discussed above (e.g., remotely on a remote system 440). That is, in some instances, the work management application is configured to generate the various work item information (e.g., generating the map graphic 1202 and/or the navigation path 1202, identifying obstacles or items of interest along the route between the vehicle 10 and the work item, generating/using geofences associated with work items, automatically requesting access credentials for the operator, notifying the operator that PPE is required along the route, etc.) may be performed remotely by the work management application and communicated to the dynamic work application.

After providing the various work item information to the operator of the vehicle 10, at step 1306, the dynamic work application then receives various work item progress information, at step 1308, and, in some instances, performs various auxiliary work tasks using the work item progress information, at step 1310.

For example, the dynamic work application may continuously monitor a location of the vehicle 10 and determine that and/or prompt the operator to confirm whether the operator has begun a selected work item when the vehicle 10 enters the geofenced area created for the work item. The dynamic work application may similarly determine that and/or prompt the operator to confirm whether the operator has completed the selected work item when the vehicle 10 subsequently leaves the geofenced area created for the work item. In either of these instances, the dynamic work application may be configured to automatically track the time it takes for the operator to complete the work item.

In some instances, the dynamic work application may further allow for the user to indicate that they forgot a tool or other item necessary for completing the work item (e.g., verbally indicating “I forgot tool x”). In these instances, the dynamic work application may pause the work timer, restart the work timer, and/or otherwise adjust the work timer or navigation path 1210 as appropriate.

In some instances, the dynamic work application may communicate the aforementioned information (e.g., in real-time or after the work item has been completed) to various other systems (e.g., the remote system 440) and/or applications (e.g., the workflow management application), which may log this information and/or utilize this information to update and/or continuously train associated machine learning models (e.g., those used by the workflow management application).

In some instances, the dynamic work application may additionally or alternatively determine that the operator has begun and/or ended the selected work item using one or more sensors 90 of the vehicle 10. For example, the dynamic work application my utilize the occupant sensor 92 to determine when the operator has exited and reentered the vehicle 10 to track when the operator begins and ends the corresponding work item. Similarly, the dynamic work application may utilize one or more cameras on board the vehicle 10 and/or inputs from the user (e.g., voice commands and/or interactions with the dynamic work interface 1200) to determine when the work item is started and completed.

In some instances, the dynamic work application may further monitor a progress of the operator as they work through the work item and, in some instances, include or provide a work item virtual assistant (e.g., answering various questions from received from the operator, filling out various paperwork, etc.). For example, in some instances, the dynamic work application is configured to monitor the worker (e.g., via one or more cameras, microphones, etc.) as they perform the work item, and the worker may periodically report to the vehicle 10 (e.g., verbally as they are performing the work item, via interaction with the dynamic work interface 1200, using the removable earpiece 49, etc.) regarding their progress.

As an example, the work item may have a plurality of sub-tasks associated therewith. Accordingly, the operator may let the dynamic work application know every time a sub-task has been completed. As discussed herein, the dynamic work application is configured to provide a voice-based or text-based chat-bot or virtual assistant that may allow the operator to explain verbally what they are doing, and the dynamic work application is configured to monitor the operators progress via an ongoing conversation with the operator.

Additionally, in some instances, the dynamic work application is configured to respond to periodic questions from the operator regarding the work item and how to go about performing various sub-tasks. For example, during a maintenance work item, the operator may ask the dynamic work application what is required for the work item (e.g., “what size screws do I need for this item,” “what size bolts do I need for this work item,” “what tools do I need for this work item,” etc.). In these cases, the dynamic work application may be trained to answer a variety of questions regarding work items based on the same or similar structured or unstructured training data to that discussed above, with respect to the workflow management application. In some instances, the dynamic work application is further configured to access various functionality of the vehicle 10 (e.g., via the communications interface 106), such that the operator can similarly ask the dynamic work application to perform various vehicle-related commands. For example, upon arriving at the work item location, the operator may verbally ask the dynamic work application to shut down the vehicle 10 (or to start the vehicle 10), to enable access to one or more tools onboard the vehicle 10, etc.

In some instances, the dynamic work application is further configured to enable various automated processes (e.g., auxiliary work tasks) while the work item is being completed. For example, employees (e.g., maintenance workers, operators of utility vehicles on commercial properties, etc.) often need to interact with a variety of business applications (e.g., filling out work item notes in a work tracker system or application, submitting requests to facilities systems, checking progress of work orders, etc.). Accordingly, utilizing its speech-to-text (and vice versa) capabilities, the dynamic work application is configured to automatically fill out various forms and requests as the operator is completing the work item based on verbal commands and/or observations from the operator.

For example, in some instances, the operator may provide various verbal notes regarding descriptions of the work being done, materials used, and any other relevant observations, and the dynamic work application is configured to generate structured notes to be used for tracking purposes. The dynamic work application may then interface with a third-party system (e.g., a work tracking system) to upload the notes, along with any pertinent vehicle data pulled from the vehicle 10 (e.g., vehicle location, time, etc.) to provide comprehensive documentation regarding the work item completion. Similarly, the operator may provide various additional commands regarding submitting requests and/or placing or checking the progress of work orders, and the dynamic work application is configured to interface with appropriate third-party applications, as necessary. In some instances, the dynamic work application is configured to allow the operator to ask for an item to be autonomously delivered to them to aid in their performance of the work item. For example, the dynamic work application may interface with one or more third-party applications configured to initiate autonomous delivery of tools, hardware, and/or other items for use in completing a particular work item.

In some instances, the dynamic work application is further configured to track the operator's progress while the operator is off of the vehicle 10. For example, in some instances, the operator may carry one or more remote communication devices that may be configured to communicate with the dynamic work application running on the vehicle control system 100 (e.g., via a short range communication network, via the communications network 410, etc.). In some instances, the removeable earpiece 49 on the vehicle 10 is configured to communicate directly with the vehicle 10 via the communications network 410. For example, the removeable earpiece 49 may be removably attached to a charging port and holder of the vehicle 10. While the removeable earpiece 49 is shown on the side of the vehicle 10 in FIG. 1, it should be appreciated that it may be disposed elsewhere on the vehicle 10 (e.g., on the dashboard of the vehicle 10). In some instances, the removeable earpiece 49 is configured for short-range communication and, when out of range of the vehicle 10, instead communicates with the user device 432, which then communicates with the vehicle control system 100 via the communications network 410.

Accordingly, the use of the removeable earpiece 49 and/or the user device 432 allows for the operator to continue using and communicating with the dynamic work application while performing the work item off of and/or away from the vehicle 10. In some instances, the dynamic work application continues to run and interface with various third-party business applications (e.g., via the communications network 410) while the operator is off of the vehicle 10 and communicating with the dynamic work application via the remote communication device. Further, in some instances, the dynamic work application may track the user's location (e.g., based on GPS data from the user device 432 and/or the removeable earpiece 49), which may similarly be tracked and logged with the rest of the work notes discussed herein.

Once the operator has completed the work item, the dynamic work application then marks the work item complete, at step 1312. In some embodiments, the dynamic work application may communicate this completion status of the work item to the workflow management application discussed above. In some embodiments, the dynamic work application may continuously inform the workflow management application discussed above regarding the progress status of the operator's work items to allow for real-time work progress information to be utilized while prioritizing work items across a fleet of vehicles of a plurality of employees.

While the descriptions of the workflow management application and the dynamic work application provided herein refer predominantly to the vehicle 10 and its components, it should be appreciated that the workflow management application and/or the dynamic work application may be similarly displayed on and/or otherwise implemented within the vehicle 210, and that the descriptions of the workflow management application and the dynamic work application may be similarly applicable to the vehicle 210 and its components.

Now that the workflow management application and the dynamic work application have each been generally described, a variety of potential use cases are provided below. It should be appreciated that the following use cases are provided as examples, and are in no way meant to be limiting. In other embodiments, the applications, systems, and/or methods described herein may be applied to various other situations without departing from the scope of the present disclosure.

As one example, a university campus may have a plurality of maintenance, landscaping, and/or security workers that utilize respective utility vehicles (e.g., vehicle 10, vehicle 210, etc.) to perform various maintenance, landscaping, and/or security tasks throughout the campus. The workflow management application described herein may be configured to identify all of the work items to be performed on the campus, prioritize those work items for each worker working during a given work period, and provide a list of selectable work items to the dynamic work application to be displayed or otherwise conveyed to the operator for selection.

The worker may then receive the list of selectable work items (e.g., displayed via the dynamic work interface 1200 on the operator interface 48) and select a work item to perform. The dynamic work application may then update the status of the work item to “En Route,” calculate the estimated time of arrival based on the current trajectory of the vehicle 10 (e.g., based on vehicle information pulled from the vehicle 10), and provide this information to the workflow management application. Upon arriving at the work item location, the dynamic work application may mark the work item as “In Progress,” begin time tracking the work item, and similarly provide this information to the workflow management application.

Once at the work location, the worker may exit the vehicle 10, remove and put on the removeable earpiece 49 from the vehicle 10, and begin performing the work item. While performing the work item, the operator may verbally update the dynamic work application regarding the details of the worker's performance of the work item, which may be transcribed, communicated to the workflow management application, and logged in the appropriate third-party systems. Once the work item is completed and the worker departs the work item location, the dynamic work application updates the work item status to “Completed” and relays this information to the workflow management application.

In some embodiments, the dynamic work application may be utilized by security crews at a venue, arena, or other location needing security. For example, security team members generally have to drive to different locations and fill out various paperwork or otherwise confirm that they checked on/secured various area. For example, security may have to drive to a location to be secured and then get out and walk through a building to secure the area. By utilizing the dynamic work application, the security team members may simply report verbally (e.g., via the removeable earpiece 49) in real-time as they are checking and securing the areas, and the dynamic work application can automatically fill out any necessary paperwork and/or other forms.

In some embodiments, the dynamic work application may be utilized by law enforcement to automatically issue and/or initiate a citation process via a verbal command given to the dynamic work application (e.g., via the removeable earpiece 49). Additionally, the workflow management application could be utilized by law enforcement and/or security teams to respond appropriately to emergency situations based on which law enforcement officer and/or security personnel is closest to an event, what their skills/credentials are, what deployable assets they have on hand (e.g., voice-activated drone systems, the deployable accessories 1508 discussed below, etc.), etc.

Similarly, an emergency response team may utilize the workflow management application to respond to an emergency situation at a sporting event, stadium, or campus. For example, if a person is injured and needs a stretcher, the workflow management application could automatically prompt a nearby vehicle 10 equipped with a stretcher to a location of the injured person (e.g., which would be the “work item location” in the above descriptions). In some instances, the workflow management application may additionally manage one or more driverless (e.g., autonomous) vehicles, and may similarly be able to determine what equipment the driverless vehicles have on board. As such, in the preceding example with an injured person needing a stretcher, if the workflow management application determines that an autonomous vehicle that is nearby has a stretcher, the workflow management application may send the autonomous vehicle to the location of the injured person.

It will be appreciated that the workflow management application and/or the dynamic work application may be used in a variety of other contexts by various other types of workers. For example, either of these applications may be utilized in other large facility management contexts, other municipal or city services management contexts, music venue contexts, etc.

Accordingly, the workflow management application and the dynamic work application provide a variety of benefits over traditional workflow systems and task trackers. For example, traditionally, maintenance workers and other similar workers have used tablets or mobile devices to interact with business applications, but vehicle data has not be incorporated into the application. Further, paperwork and tracking work items and progress have traditionally been performed manually after the fact, which has increased the likelihood of manual human errors and erroneous data. Meanwhile, the workflow management application and dynamic work application described herein provide integrated applications that are designed to enhance the efficiency and management of various work items (e.g., maintenance tasks) by integrating interactive mapping, vehicle data, business system data, BIM data, voice-controlled notetaking, and the various additional information described herein with LLM and/or various other AI-based application features to effectively enable dynamic and accurate tracking, prioritization, and assistance with work items.

### Context-Based Virtual Assistant on Vehicle

Referring now to FIG. 14, a method 1400 for providing a context-based virtual assistant on a vehicle (e.g., the vehicle 10) is provided below. It should be appreciated that the following description is provided as an example and is in no way meant to be limiting. Furthermore, it should be appreciated that, in some embodiments, various steps may be added, omitted, and/or rearranged within the method 1400 without departing from the scope of the present disclosure.

In some embodiments, the method 1400 is performed by a separate machine learning application (e.g., another one of the machine learning models 108) stored on the vehicle control system 100 that may be configured to selectively interface with the work management application and/or the dynamic work application discussed above. For clarity, term “context-based assistant application” is used herein to refer to the machine learning application that performs the method 1400. However, it should be appreciated that, in some instances, the functionalities of the work management application, the dynamic work application, and the context-based assistant application may each be provided by a single machine-learning-based application.

In some instances, the context-based assistant application is an application associated with an application widget 704 displayed on the dock interface 700 (e.g., similar to the dynamic work interface 1200). In some other instances, the context-based assistant application is a standalone application that may be selectively accessed and utilized by third-party applications uploaded to the dock interface 700 to enable the various context-based virtual assistant functionality described herein. In either case, the context-based assistant application is configured to selectively access any of the various information accessible by the dock interface 700, the application widgets 704, and/or their corresponding applications in a similar manner to that discussed above with respect to the description of FIGS. 7-9.

Additionally, as referenced above, the various machine learning models 108 (e.g., context-based assistant application) may comprise GAI models, LLMs, and/or any other suitable machine learning models configured to allow for speech recognition and/or language generation to provide a voice-based or text-based chat-bot or virtual assistant configured to interact with the operator of the vehicle 10. In some instances, the same machine learning model 108 may provide both the functionalities of the context-based assistant application and the conversational capabilities described herein. In some instances, the context-based assistant application may include multiple machine learning models configured to interface with one another to provide both the functionalities of the context-based assistant application and the conversational capabilities described herein.

The method 1400 begins with the context-based assistant application obtaining various user information associated with a user, at step 1402. In some embodiments, the context-based assistant application is configured to monitor various sensor data associated with the user captured by the sensors 90 on board the vehicle 10. For example, in some instances, the context-based assistant application is configured to capture image data, voice data, fingerprint data, etc., pertaining to the user of the vehicle 10. In some instances, the context-based assistant application is further configured to monitor various choices, actions, requests, and/or decisions made or taken by the user (e.g., directly to the context-based assistant application and/or a separate application on the vehicle 10 and/or just spoken out loud by the user or otherwise observed by the vehicle 10).

In some instances, the user information is utilized to identify the user driving the vehicle 10 (e.g., based on image recognition and/or voice recognition performed via machine learning models of the context-based assistant application). Accordingly, as opposed to requiring the user to log into the dock interface 700 or provide another type of credential to utilize the vehicle 10, the context-based assistant application may be configured to automatically identify the user (e.g., as the user approaches the vehicle 10 and/or once the user sits down in the vehicle 10) based on image and/or voice data captured by the sensors 90 on the vehicle 10. In some instances, the context-based assistant application is configured to learn the user's voice and/or to visually recognize the user over time (e.g., “get to know” the user) as the user uses the vehicle 10 without requiring a separate identification registration or initiation process (e.g., where specific biometrics are captured for the purpose of identifying the user).

In some instances, if the user logs into a third-party application or other system (e.g., via a corresponding application widget 704 of the dock interface 700), the context-based assistant application may additionally or alternatively pull various user information pertaining to the user from the corresponding third-party system (e.g., user preferences, user tendencies, user credentials, user permissions, etc.).

As the context-based assistant application obtains the various user information, at step 1402, the context-based assistant application generates a user profile for the user based on the user information, at step 1404. For example, by utilizing the captured sensor data and/or login information to identify the user, the context-based assistant application may then begin to build a user profile for the user, which may be added to or otherwise updated over time. For example, the context-based assistant application may observe the user while the user operates the vehicle 10 and/or while the user is nearby the vehicle 10 (e.g., when the user is taking a swing during a round of golf) and continuously learn various information pertaining to the user's habits, preferences, and various other relevant information about the user.

As an example, in some instances, the context-based assistant application is configured to monitor the user as they play one or more rounds of golf and to gather information about their play. For example, the context-based assistant application may determine (e.g., based on sensor data and/or by asking the user relevant questions) which player in the vehicle 10 is hitting, how far from the hole the player is hitting from (e.g., based on GPS data of the vehicle 10 and/or other sensor data captured by sensors 90 on the vehicle 10), what club the player is using or was using during their last shot (e.g., visually determined using a camera of the vehicle 10 and/or confirmed by asking the player), how far and/or where the player's last shot went (e.g., as tracked by an automated shot tracker vehicle deployed from the vehicle 10 (e.g., one of the deployable accessories 1508 discussed below with reference to FIG. 15) and/or determined by asking the player), and/or various other information pertaining to the player's golf game. In some instances, the vehicle 10 may further be configured to monitor the player's golf swing (e.g., via one or more cameras or other sensors 90 on the vehicle 10) and to build a golf swing profile for the player, which may form part of the player's overall user profile. Accordingly, based on the various information gathered about the user's golf play, the context-based assistant application may be able to determine a skill level of the player including, for example, how far they typically hit the ball with different clubs, how frequently they hit the ball accurately, where they typically hit the ball when they do not hit the ball accurately (e.g., slice, draw, fade, hook), etc.

After the context-based assistant application has generated the user profile for the user, at step 1404, the context-based assistant application receives various context information associated with the user, at step 1406, and performs one or more actions based on the context information and the user profile, at step 1408. For example, in some instances, the context information may include various information, requests, and/or questions received directly from the user. The context information may additionally include various information and/or data received from components of the vehicle 10 (e.g., the vehicle speed, the vehicle's location information, video data captured by the sensors 90 of the vehicle 10, audio information captured by the sensors 90 of the vehicle 10, information about tools or other devices onboard the vehicle 10, etc.). The context information may additionally include various information and/or data received or otherwise obtained from third-party systems (e.g., weather data from a weather resource, scheduling and/or rule information from a golf course management system, information regarding other vehicles on a golf course, etc.).

Taking the golf example above, as the player drives the vehicle 10 during their round of golf, the context-based assistant application may identify which player is hitting (e.g., based on their voice, their face, or other recognized characteristics) and know (e.g., based on their user profile) how far the player typically hits the ball with different clubs, how far they are from the hole and what the hole looks like (e.g., based on received golf course information and real-time GPS location information obtained from the vehicle 10), what kind of weather and wind there is currently at their location (e.g., pulled from one or more third-party weather resources and/or determined via one or more of the sensors 90 on board the vehicle 10, which may include a wind sensor), and any other relevant information pertaining to the player that may be pulled from their user profile. The context-based assistant application may then suggest which club to use for a particular shot. In some instances, the context-based assistant application can additionally provide an explanation of a hole layout for first-time players (e.g., “hole one is 350 yards long and doglegs to the right”). In some instances, the context-based assistant application may provide various additional suggestions or warnings (e.g., “there is a water hazard behind the green on the right side”). In some instances, these suggestions, explanations, and/or warnings may be provided audibly or via a text chat via a chat-bot or other similar virtual assistant feature.

In some embodiments, the context-based assistant application provides various suggestions to the player without prompting from the player. For example, the context-based assistant application may determine that the vehicle 10 is approaching a tee box (e.g., based on a geofence around the tee box that is created similar to the other geofences described herein) and automatically provide the player with various information about the hole and/or with club suggestions for the hole. In some embodiments, the context-based assistant applicant may additionally or alternatively respond to verbal or text-based questions received from the player. For example, the player may ask how far out they are from the hole, what the wind speed and direction are, how their pace of play is compared to the people behind them on the course, can they safely hit their shot (e.g., “Are the players ahead of us far enough away for me to take my swing?”), etc., and the context-based assistant application may utilize the various context information to generate relevant responses to be communicated to the player. In some instances, the context-based assistant application may be configured to respond to the user's voice only after detecting a wake-up call phrase (e.g., “Hey PACE”) spoken by the user.

In some embodiments, the context-based assistant application is configured to allow for the driver of the vehicle 10 to control various operations of the vehicle 10 (e.g., in a similar manner to the various applications associated with the application widgets 704 described above). For example, in some instances, the user may verbally ask the context-based assistant application to turn the vehicle 10 on or off, to drive in a particular direction, to adjust a volume on the vehicle 10 (e.g., of the context-based assistant application and/or other audio systems on the vehicle 10), and/or to adjust operation of any other desired system or device onboard the vehicle 10.

In some embodiments, the context-based assistant application is configured to allow for the driver of the vehicle 10 to temporarily suspend various rules pertaining to the vehicle 10. For example, on a golf course, there may be various geofenced areas within which drivers are not allowed to drive in. In some instances, upon entering these geofenced areas, the vehicle 10 may typically be automatically locked down and only allowed to drive in reverse (e.g., to exit the prohibited driving area). However, in some instances, the user may indicate to the context-based assistant application that they are just turning around to get out of the area and to temporarily disable and/or adjust the geofencing rule (e.g., “I'm just turning around, please temporarily disable the geofencing.”). In some instances, the context-based assistant application may then temporarily disable and/or adjust the geofencing rule to allow the user to turn the vehicle 10 around. The context-based assistant application may further monitor the location of the vehicle 10 as the user turns the vehicle 10 around to ensure that the user is actually doing what they indicated they would do (e.g., to prevent misuse of the temporary rule adjustment). If the context-based assistant application determines that the user is not doing what they indicated they would do, the context-based assistant application may re-institute the original geofencing rule to force the user to back out as traditionally required.

In some embodiments, the temporary rule suspension capability described above are allowed based on a user permission associated with the user. For example, if a golf course manager asks the context-based assistant application to temporarily disable a geofenced area, the context-based assistant application may identify the golf course manager as described above and determine that the golf course manager is allowed to temporarily suspend or disable geofenced areas on the golf course based on a permission included in his or her user profile (e.g., which may be pulled from a third-party system associated with the golf course).

In some embodiments, the context-based assistant application provides various accessibility features. For example, a user driving the vehicle 10 may ask the context-based assistant application to read words of a screen (e.g., the operator interface 48) of the vehicle 10 and/or make words on the screen a larger size. In some instances, the context-based assistant application may additionally allow for the user to place various orders with third-party systems. For example, in some instances, the user may ask the context-based assistant application to place a food order with a golf course restaurant, and the context-based assistant application may be configured to send an order request (e.g., via the communications network 410) to a third-party system (e.g., one of the remote systems 440) associated with the golf course restaurant to place the user's food order.

While the examples above have centered around a golf cart or golf vehicle, it will be appreciated that the context-based assistant application and the method 1400 may be similarly utilized with or on a variety of other types of vehicles. For example, the context-based assistant application may be provided in the context of an automobile. In this example, the user may ask the context-based assistant application whether the automobile can fit in a particular parking spot or whether the automobile can safely make a turn. In these instances, the context-based assistant application may be configured to access various sensor information from cameras or sensors onboard the vehicle (e.g., similar to the sensors 90) and determine whether the user can fit in the relevant parking spot and/or safely make the relevant turn. It will be appreciated that the context-based assistant application may be used on a variety of vehicles for a multitude of purposes, and the examples discussed herein are provided as examples and are not meant to be limiting.

Accordingly, the context-based assistant application described herein provides a virtual assistant that is integrated within a vehicle (e.g., the vehicle 10) and its underlying systems (e.g., the operator controls 40, the driveline 50, the suspension system 60, the braking system 70, the sensors 90, etc.), allowing for driver identification, vehicle control, and enhanced user experience in both commercial and recreational contexts.

### Vehicle Interface for Deployable Accessories

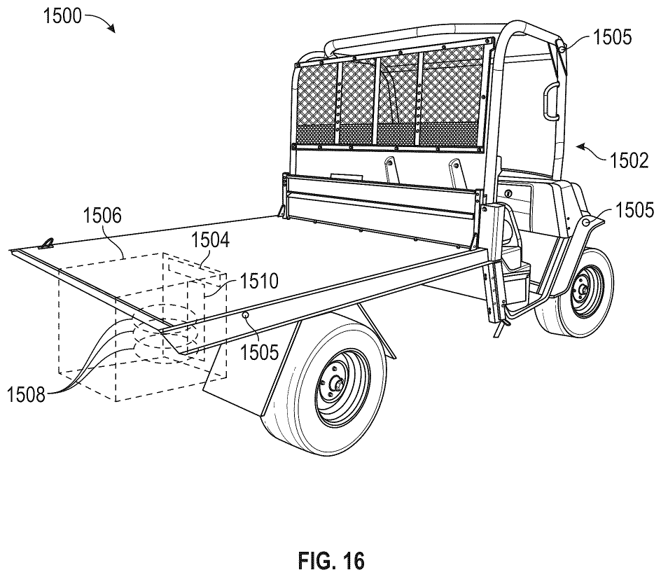

As shown in FIGS. 15 and 16, a vehicle system, shown as vehicle system 1500, includes a vehicle (e.g., the vehicle 10, the vehicle 210, etc.), shown as vehicle 1502, having a vehicle control system, shown as vehicle control system 1503, a deployable accessory interface or deployable vehicle interface, shown as deployable accessory interface 1504, a deployable accessory base or deployable vehicle base, shown as deployable accessory base 1506, and a plurality of deployable accessories or deployable vehicles, shown as deployable accessories 1508. In some embodiments, the vehicle system 1500 allows for the transport and deployment of autonomous accessories (e.g., the deployable accessories 1508) that are able to communicate with and/or utilizes various functionalities of the vehicle 1502 via a standardized interface (e.g., the deployable accessory interface 1504). It should also be appreciated that the deployable accessory features and functionalities of the vehicle system 1500 described below may be similarly applied to and/or incorporated into the vehicle 10 and/or the vehicle 210, as desired for a given application.

In some embodiments, the vehicle 1502 may be a hauler, a diamond plate vehicle, a transport vehicle, and/or any other type of vehicle described herein (e.g., the vehicle 10, the vehicle 210, etc.). In some embodiments, the vehicle 1502 includes the same or similar components, systems, and features as those described herein with respect to the vehicle 10 and/or the vehicle 210. The vehicle 1502 may additionally include one or more deployable accessory aid devices 1505 (e.g., location beacons, audio sensors, visual sensors or cameras, etc.) configured to communicate with and/or monitor the deployable accessories 1508 during operation.

The vehicle control system 1503 may be the same as or substantially similar to the vehicle control system 100 and/or the vehicle controller 300 discussed above. For example, the vehicle control system 1503 may similarly include a processing circuit (e.g., similar to the processing circuit 102) and a memory (e.g., similar to the memory 104) having one or more applications programmed therein (e.g., the dock interface 700, the work management application, the dynamic work application, the context-based assistant application, and/or the deployable accessory application discussed below) that are configured to communicate with the deployable accessory base 1506 (and thus the deployable accessories 1508) via the deployable accessory interface 1504 to enable the various functionalities discussed herein. In some instances, the vehicle control system 1503 is configured to at least partially autonomously control the vehicle 1502 to perform various actions (e.g., drive the vehicle 1502 between locations within a known area, perform an automated parking operation, etc.).

In some embodiments, the deployable accessory interface 1504 includes a standardized mounting that may be configured to physically receive and detachably couple to the deployable accessory base 1506 (e.g., the deployable accessory base 1506 can plug into the deployable accessory interface 1504). The deployable accessory interface 1504 further electrically couples and allows for communication between the vehicle control system 1503 and the deployable accessory base 1506. Accordingly, the deployable accessory interface 1504 is able to communicate various vehicle information pertaining to the vehicle 1502 from the vehicle control system 1503 to the deployable accessory base 1506 and, ultimately, to the deployable accessories 1508. The deployable accessory interface 1504 can further receive and transmit various progress and/or other information from the deployable accessories 1508 (e.g., received via the deployable accessory base 1506) back to the vehicle control system 1503. In some embodiments, the deployable accessory interface 1504 is further configured to allow for various third-party sensors (e.g., one of the deployable accessory aid devices 1505) to be coupled to it (e.g., plugged into it) to be used in conjunction with the deployable accessories 1508, as will be described below. In some embodiments, the deployable accessory interface 1504 is further configured to provide power from the vehicle 1502 to the deployable accessory base 1506 (e.g., and thereby the deployable accessories 1508).

As an example, in some instances, the deployable accessory interface 1504 includes a CAN bus connector that allows for third parties to develop their own deployable accessory bases (e.g., the deployable accessory base 1506) and corresponding deployable accessories (e.g., the deployable accessories 1508) that are able to communicate and interact with the vehicle control system 1503 and various components and features of the vehicle 1502 (e.g., any of the systems and/or applications described herein). In some instances, the deployable accessory interface 1504 communicates various information to the deployable accessory base 1506 and/or the deployable accessories 1508 (e.g., based on commands from and/or programming of the deployable accessory application discussed below). For example, the deployable accessory interface 1504 may communicate information pertaining to operator controls (e.g., the operator controls 40), a driveline (e.g., the driveline 50), a suspension system (e.g., the suspension system 60), a braking system (e.g., the braking system 70), various sensors (e.g., the sensors 90), various machine learning models (e.g., the machine learning models 108), and/or applications (e.g., any of the applications associated with the application widgets, the workflow management application, the dynamic work application, the context-based assistant application, etc.) of the vehicle 1502 and/or information from one of the remote systems 440 (e.g., regarding other vehicles in a fleet of vehicles) to the deployable accessory base 1506 and/or the deployable accessories 1508.

Similarly, the deployable accessory interface 1504 communicates information from the deployable accessory base 1506 and/or the deployable accessories 1508 back to the vehicle control system 1503 to be utilized by the vehicle control system 1503, machine learning models (e.g., the machine learning models 108), and/or applications (e.g., any of the applications associated with the application widgets, the workflow management application, the dynamic work application, the context-based assistant application, etc.) of the vehicle 1502 and/or further communicated to one of the remote systems 440 to facilitate the functions described herein.

In some embodiments, the deployable accessory base 1506 is configured to detachably couple with, connect to, or plug into the deployable accessory interface 1504 and receives power from the deployable accessory interface 1504. In some instances, the deployable accessory base 1506 (as well as the deployable accessories 1508) may be built and/or developed by the OEM of the vehicle 1502. In other instances, the deployable accessory base 1506 (as well as the deployable accessories 1508) may be built and/or developed by a third party. As shown in FIG. 16, the deployable accessory base 1506 has a generally box-shaped container that is configured to store and facilitate selectively deploying the plurality of deployable accessories 1508. In some instances, the deployable accessory base 1506 may be integrated within or coupled to (e.g., on top of, beneath, etc.) a bed of the vehicle 1502 (as shown in FIG. 16). In some instances, a top surface of the deployable accessory base 1506 may form a portion of the bed of the vehicle 1502. In some other instances, the deployable accessory base 1506 may instead sit on top of the bed and/or may be located elsewhere on the vehicle 1502. Accordingly, in these instances, the deployable accessory interface 1504 may be similarly located elsewhere on the vehicle 1502.

In some instances, the plurality of deployable accessories 1508 are deployed by the deployable accessory base 1506 via an accessory deployment mechanism, shown as accessory lift 1510. The accessory lift 1510 is configured to selectively deploy and/or collect the deployable accessories 1508 to initiate or upon completion of various tasks performed by the deployable accessories 1508, as will be described further below. In some embodiments, the accessory lift 1510 comprises a lift (e.g., similar to a forklift) or elevator mechanism configured to selectively engage, disengage, and move the deployable accessories 1508 vertically within the deployable accessory base 1506 to selectively deploy the deployable accessories 1508. In some other instances, the accessory lift 1510 may include a slide or chute configured to allow for the deployable accessories 1508 to be selectively allowed to drop out of and be collected by the deployable accessory base 1506. In some instances, the accessory lift 1510 may include a deployable ramp or other features upon which the deployable accessories 1508 can drive up and down.

In some instances, the deployable accessory base 1506 is configured as an edge controller or computer and includes a processing circuit (e.g., similar to the processing circuit 102) and a memory (e.g., similar to the memory 104) having one or more applications programmed therein that are configured to communicate with the vehicle control system 1503 (e.g., and thus the various components of the vehicle 1502) and the deployable accessories 1508 to enable the deployable accessories 1508 to perform various tasks, as described further below. In some instances, the deployable accessory base 1506 is configured to communicate with the deployable accessories 1508 via a short-range wireless signal (e.g., low-range Bluetooth, ultra-wideband, etc.) or via a long-range wireless signal (e.g., cellular, Wi-Fi, etc.).

In some instances, the deployable accessory base 1506 is provided and programmed by a third party (i.e., a different entity than the OEM associated with the vehicle 1502). For example, the deployable accessory interface 1504 and information accessible from the vehicle control system 1503 may have standardized programming call outs (e.g., via ROS programming language callouts, HTTP communications, API calls, etc.) that may be utilized by third parties in developing their own software and accessories that selectively incorporate information and functionalities of the vehicle 1502 to be utilized while operating the deployable accessories 1508.

In some embodiments, the deployable accessories 1508 include a plurality of autonomous and/or deployable devices or vehicles configured to perform various automated tasks. Accordingly, the deployable accessories 1508 may each include a control unit (e.g., similar to the vehicle control system 100) configured to store (e.g., in a memory similar to the memory 104) and process (e.g., using a processing circuit similar to the processing circuit 102) various onboard programs and applications to complete their respective automated tasks. In some instances, the deployable accessories 1508 may be configured to run applications that utilize various machine learning models (e.g., similar to the machine learning models 108) to complete their respective automated tasks.

The deployable accessories 1508 may include any deployable accessories developed by the OEM of the vehicle 1502 and/or third parties for use with the vehicle 1502. As used herein, the term “deployable” is used to refer to the capability of the deployable accessories 1508 to autonomously move between land, water, and/or airborne locations to perform various automated tasks. For example, in some instances, the deployable accessories 1508 may each include various movers or movement mechanisms, such as robotic legs, powered wheels, propellers for aquatic movement, rotor blades for flight, etc.

In some embodiments, the deployable accessories 1508 may include one or more of automated mower devices configured to perform automated lawn mowing operations, smart edger devices configured to perform an automated edging operation (e.g., around a bunker), automated trash collector robots configured to collect trash from an area, automated shot tracking devices configured to automatically deploy from the vehicle 1502 (or the vehicle 10) and track one or more users'golf shots, automated drones configured to monitor an area (e.g., perform automated land surveying), automated parking lot sweepers configured to automatically sweep or otherwise clean a parking lot, automated burden carriers configured to transport or carry tools and/or other similar items for workers, etc. It should be appreciated that these potential deployable accessories are provided as examples and are in no way meant to be limiting.

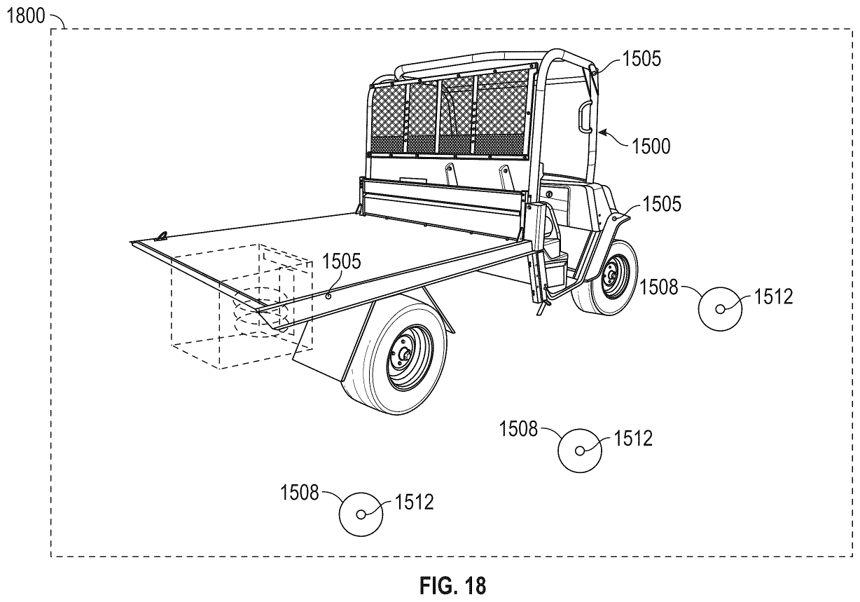

Accordingly, in some embodiments, the vehicle system 1500 is configured to allow for multiple accessory vehicles (e.g., the deployable accessories 1508) having higher levels of autonomy or autonomous functionality (e.g., fully autonomous vehicle) to be carried and/or otherwise transported by the vehicle 1502 (e.g., having a lower level of or no autonomy) and deployed at a particular work location (e.g., the work area 1800 shown in FIG. 18). The deployable accessories 1508 can further communicate with various components and/or applications running on the vehicle 1502 via the connection between the deployable accessory interface 1504 and the deployable accessory base 1506. In some instances, the vehicle control system 1503, the deployable accessory interface 1504, and/or the deployable accessory base 1506 are configured to communicate in a ROS language (e.g., the ROS 2 framework) and/or to translate communications between the ROS language and another programming language (e.g., HTTP, Java, JavaScript, etc.). Accordingly, information obtained from the various components and/or sensors of the vehicle 1502 may be effectively communicated to the deployable accessory base 1506 and the deployable accessories 1508, and information obtained from various components and/or sensors of the deployable accessories 1508 can similarly be communicated back to the vehicle control system 1503.

In some embodiments, various components on the vehicle 1502 may include self-contained edge processing devices that may communicate directly with the deployable accessory interface 1504, the deployable accessory base 1506, and/or the deployable accessories 1508 (e.g., via a wired or wireless connection). Accordingly, in some instances, the vehicle system 1500 may utilize a microservices-based architecture that allows for various functionalities to happen and/or applications to run in parallel to improve responsiveness of the vehicle system 1500.

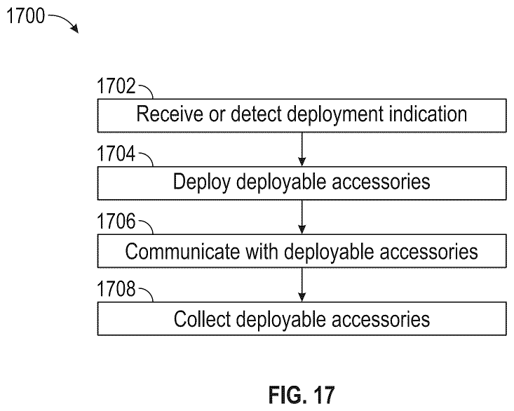

Referring now to FIG. 17, a method 1700 for deploying and enabling autonomous accessories is provided below. It should be appreciated that the following description is provided as an example and is in no way meant to be limiting. Furthermore, it should be appreciated that, in some embodiments, various steps may be added, omitted, and/or rearranged within the method 1700 without departing from the scope of the present disclosure.

In some embodiments, the method 1700 is performed by a separate application stored within the memory of the vehicle control system 1503 and configured to communicate with the deployable accessory base 1506 and the deployable accessories 1508. In some instances, the vehicle control system 1503 may receive and store a machine learning application developed by a third party (e.g., a manufacturer of the deployable accessories 1508) from a third party system (e.g., one of the remote systems 440 over the communications network 410) that includes one or more machine learning models (e.g., similar to the machine learning models 108) configured to enable autonomous performance of various tasks by the deployable accessories 1508. For clarity, the term “deployable accessory application” is used herein to refer to the machine learning application that performs the method 1700. However, it should be appreciated that, in some instances, the functionalities of the deployable accessory application and one or more of the applications described above (e.g., the work management application, the dynamic work application, the context-based assistant application) may be provided by a single machine-learning-based application.

In some instances, the deployable accessory application may similarly be an application associated with an application widget 704 displayed on the dock interface 700 on a display of the vehicle 1502. In some other instances, the deployable accessory application may be a standalone application that may be selectively accessed and utilized by third-party applications uploaded to the dock interface 700 to deploy, enable, and/or monitor autonomous performance of various tasks via the deployable accessories 1508. In either case, the dynamic work application is configured to selectively access any of the various information accessible by the dock interface 700, the application widgets 704, and/or their corresponding applications in a similar manner to that discussed above with respect to the description of FIGS. 7-9. The dynamic work application is further configured to selectively provide any of this information to the deployable accessory base 1506 and/or the deployable accessories 1508 (e.g., via the deployable accessory interface 1504) to enable the functionality described herein.

As shown in FIG. 17, the method 1700 begins with receiving or detecting a deployment indication, at step 1702, and to deploy the deployable accessories 1508, at step 1704. For example, in some instances, an operator of the vehicle 1502 is able to selectively deploy the deployable accessories 1508 via interaction with a button on the deployable accessory base 1506 or on an application widget (e.g., one of the application widgets 704) displayed to the operator via within a dock interface (e.g., the dock interface 700) displayed on the vehicle 1502 (e.g., on the operator interface 48). Accordingly, upon receiving the indication from the operator to deploy the deployable accessories 1508, the deployable accessory application may deploy the deployable accessories 1508 via the accessory lift 1510 of the deployable accessory base 1506 (e.g., via communication with the deployable accessory base 1506 through the deployable accessory interface 1504).

As shown in FIG. 18, the deployable accessory application may be configured to automatically deploy the various deployable accessories upon the vehicle 1502 entering a work area, shown as a work area 1800. For example, in some instances, the deployable accessory application is configured to monitor a location of the vehicle 1502 (e.g., based on GPS location information of the vehicle 1502), and the work area may be located within a created geofence (e.g., similar to the other created geofences described herein). Accordingly, upon the vehicle 1502 entering the geofenced area, the deployable accessory application is configured to detect that the vehicle 1502 has entered the geofenced area and automatically deploy the deployable accessories 1508 via the accessory lift 1510 of the deployable accessory base 1506 (e.g., when the vehicle 1502 comes to a stop within the work area 1800).

In some embodiments, the deployable accessories 1508 are programmed to automatically perform certain tasks without additional instructions from the deployable accessory application. For example, in some instances, the deployable accessories 1508 may be pre-programmed to perform one or more specific actions based on identified constraints (e.g., boundaries formed by the perimeter of the work area 1800). In some other embodiments, the deployable accessory application may provide various instructions and/or additional constraints for performing the tasks to the deployable accessories 1508 upon or prior to deployment of the deployable accessories 1508. For example, in some instances, a user (e.g., a fleet manager, a campus landscaping planner, etc.) may create, update, and/or otherwise modify instructions for the deployable accessories 1508 via one of the remote systems 440 and/or via an application widget 704 associated with the deployable accessory application accessible via the dock interface 700.

After deploying the deployable accessories 1508, at step 1704, the deployable accessory application and/or various components of the vehicle 1502 may be configured to communicate with the deployable accessories 1508 as they performed their automated tasks, at step 1706. For example, in some instances, the deployable accessory application may obtain various information from the components of the vehicle 1502 (e.g., real-time speed of the vehicle 1502, real-time location of the vehicle 1502, camera or other sensor data captured by a camera or other sensors on the vehicle 1502, etc.), from any of the remote systems 440 (e.g., map information associated with the work area 1800), and/or from any third-party resources (e.g., Google Maps®, weather tracking entities) in a similar manner to that described above, with respect to the applications associated with the dock interface 700. The deployable accessory application may then communicate this information to the deployable accessories 1508 (e.g., through the deployable accessory base 1506) to aid in or otherwise guide their performance of their respective automated tasks. In some instances, the deployable accessory application may be configured to adjust operation of the deployable accessories 1508. For example, in some instances, an operator of the vehicle 1502 may be able to selectively command (e.g., via an application widget 704 associated with the deployable accessory application) the various deployable accessories 1508 to stop performing their respective tasks and return to the vehicle 1502.

Similarly, the deployable accessory application can receive various information from the deployable accessories 1508, such as a location, job progress, speed or trajectory, and/or any other relevant information. The deployable accessory application may then utilize that information in controlling the deployable accessories 1508, display that information to an operator of the vehicle 1502 (e.g., via one of the application widgets 704), and/or relay that information back to any other applications (e.g., any of the various applications described herein) stored or otherwise running on the vehicle 1502 and/or on one or more third-party systems (e.g., the remote systems 440) that are configured to interface with the deployable accessory application. For example, in some instances, the information from the deployable accessories 1508 (e.g., the job progress information) may be communicated to the work management application to aid in prioritizing work items for performance by employes and/or to the dynamic work application to be displayed to the user performing the associated work item via a corresponding application widget 704.

In some embodiments, the deployable accessories 1508 may be configured to detect or receive signals from deployable accessory aid devices 1505 and utilize the detected signals to aid in performance of their automated tasks. In some instances, the deployable accessory aid devices 1505 may be part of the vehicle 1502. In other instances, the deployable accessory aid devices 1505 may be attached to the vehicle 1502 by a third party (e.g., the entity in charge of the vehicle 1502) and may be communicably connected to the deployable accessory interface 1504 (e.g., via a wired or wireless connection). For example, in some instances, the deployable accessory aid devices 1505 may comprise one or more location anchors or beacons on the vehicle 1502, and the deployable accessories 1508 may utilize these detected signals to triangulate their own positions relative to the vehicle 1502 to aid in performing their respective automated tasks. In some instances, multiple location anchors or beacons may be utilized on the vehicle 1502 to improve the accuracy of these triangulations. Similarly, in some embodiments, as shown in FIG. 18, the deployable accessories 1508 each include one or more sensors 1512. Accordingly, in some instances, the deployable accessories 1508 are additionally configured to detect signals emitted by other deployable accessories to similarly triangulate their own positions relative to other deployable accessories 1508.

In some embodiments, the deployable accessory application determines a location of the vehicle 1502 within the work area 1800 based on GPS information for the vehicle 1502, camera or other sensor data captured by a camera or other sensor of the vehicle 1502, and/or map information received from one or more of the remote systems 440. The deployable accessory application then provides the vehicle location and map information pertaining to the work area 1800 to each of the deployable accessories 1508 via the deployable accessory base 1506. The various deployable accessories 1508 can then navigate within the work area 1800 by continuously triangulating their positions with respect to the vehicle 1502 and the other deployable accessories 1508 as described above.

As such, the deployable accessories 1508 may not need to have their own geolocation devices and/or other location-based technologies. That is, in some instances, the deployable accessories 1508 only need to navigate within the work area 1800 they are brought to by the vehicle 1502, which may be predefined and contained. Accordingly, the deployable accessories 1508 do not need to know the layout or configuration of an entire campus or work site and can instead only receive and process information pertaining to the designated work area 1800 and any relevant operation instructions, thereby reducing the computational burden placed on and the computational capabilities required by the deployable accessories 1508 to operate properly.

Upon completion of their respective automated tasks, the deployable accessory application may cause the various deployable accessories 1508 to be collected, at step 1708. For example, in some instances, the deployable accessory application commands the deployable accessories 1508 to return to the deployable accessory base 1506 and commands the deployable accessory base 1506 to collect the deployable accessories 1508 (e.g., via the accessory lift 1510). In some other instances, the operator may manually collect the deployable accessories 1508 and place them back in the deployable accessory base 1506.

Now that the general method 1700 has been described above, several potential use cases are discussed below. It should be appreciated that the following potential use cases are provided as examples, and are in no way meant to be limiting.

As one example, the vehicle 1502 may be a large lawn mower (e.g., similar to the vehicle 210) and deployable accessories 1508 may be a plurality of smaller autonomous lawn mowers. Accordingly, the large lawn mower may be driven to or near one or more work areas, such as a golf green, a tee box, an area near a golf clubhouse, etc. The large lawn mower may then drop off or deploy one or more of the smaller autonomous lawn mowers at each of the work areas to mow those areas while the larger lawn mower (e.g., the vehicle 1502) mows a larger area, such as a fairway on the golf course. For example, in some instances, an operator of the large lawn mower may push a button (e.g., on a touchscreen interface such as one of the application widgets 704 or a physical button on the deployable accessory base 1506). In other instances, one or more of the smaller autonomous lawn mowers may automatically be deployed when the larger lawn mower enters a geofence corresponding to each of the various work areas.

Upon or before dropping off each of the smaller autonomous lawn mowers, the large lawn mower may provide a variety of information and/or instructions to the smaller autonomous lawn mower. For example, the large lawn mower may determine its location based on GPS data, as described herein, and may provide its location and map information associated with the corresponding work area to each smaller autonomous lawn mower. Each smaller autonomous lawn mower may then determine where it is within the work area based on its relative location with respect to the large lawn mower (e.g., by triangulating its position as described above). The large lawn mower may further provide mowing instructions to the smaller autonomous lawn mower, such as where within the work area 1800 to mow (e.g., an indication of a particular green to be mowed within the work area 1800, as well as an indication of its shape and location relative to other areas within the work area 1800), what height or length to mow different areas within the work area, etc.

Accordingly, while the operator of the large lawn mower is mowing the larger area, the smaller autonomous lawn mowers can each mow their respective work areas. Additionally, as the smaller autonomous lawn mowers mow their respective work areas, they can each send progress updates to the large lawn mower, which may be presented to the operator of the large lawn mower via one of the application widgets 704 associated with the deployable accessory application discussed above. In some instances, once the operator has finished mowing the larger area and the smaller autonomous lawn mowers have each finished mowing their respective areas, the large lawn mower may then go and pick up each of the smaller autonomous lawn mowers. For example, the operator of the large lawn mower can drive the large lawn mower to or near the various work areas, and the smaller autonomous lawn mowers can each travel to and be picked up by the deployable accessory base 1506.

It will be appreciated that various additional or alternative deployable accessories may be utilized to aid in a mowing operation and/or to perform a mowing operation while an operator performs another task. For example, in some instances, the deployable accessories 1508 may be mobile locational beacons configured to deploy from the vehicle 1502, which may be a larger mower. In this case, the deployable accessories 1508 may be configured to travel to or near various hard-to-see obstacles or other points of interest (e.g., within or near a bunker, near the edge of a green, etc.). Accordingly, the vehicle 1502 may detect the deployable accessories 1508 as the vehicle 1502 approaches the obstacles and either automatically avoids them or provides an alert to the operator of the vehicle 1502 to avoid the obstacles. After mowing, these deployable accessories 1508 can similarly be picked up by the vehicle 1502.

Similarly, in another example, the operator of the vehicle 1502 may be a university campus landscaper and the vehicle 1502 may be a hauler, a UTV, a golf cart, or any other suitable vehicle for use by the operator. In this instance, the deployable accessories 1508 may similarly be a plurality of small autonomous mowers. Accordingly, the operator can drive to a work zone (e.g., the work area 1800) and the deployable accessory application and/or the operator can provide instructions to the deployable accessories 1508 regarding which areas within the work area 1800 to mow. The operator and/or the vehicle 1502 can then deploy the deployable accessories 1508, which can then begin mowing their respective areas. As the smaller mowers mow their respective areas, the operator (e.g., the landscaper) can tend to various additional tasks (e.g., trimming hedges, weeding, spreading mulch, etc.).

As another example, in some instances, the vehicle 1502 may be a transport hauler or other similar vehicle, and the deployable accessories 1508 may be one or more automated burden carriers configured to follow and carry various tools and/or other burdens for them as they perform various tasks. In some instances, one or more of the deployable accessories 1508 may be configured to autonomously retrieve tools, components, and/or other items (e.g., from a pre-determined tool area, warehouse, or other similar location) for the operator for use while they complete their tasks. For example, in some instances, the deployable accessory application running on the vehicle control system 1503 may allow for the operator to request retrieval of various tools, components, or other items (e.g., via a voice command or a text-based command received via a corresponding application widget 704).

As yet another example, in some instances, the vehicle 1502 may be a golf cart (e.g., similar to the vehicle 10), and the deployable accessory 1508 may be an automated shot tracking device. In this example, as the golfer is playing a golf round, the deployable accessory application (e.g., running on the vehicle 1502) may be configured to ask the golfer when they stop the vehicle 1502 whether they are about to hit a golf ball (e.g., via an audio-based virtual assistant or other chat bot feature, as described herein). If the golfer indicates that they are about to hit a golf ball, the automated shot tracking device may automatically deploy from the vehicle 1502 and arrange itself behind where the golfer is setting up to hit their golf ball.

For example, in this instance, the deployable accessory 1508 may include one or more cameras or other sensors that may allow the deployable accessory 1508 to arrange itself in the correct location based on where the golfer's golf ball is (e.g., identified by the one or more cameras or other sensors of the deployable accessory 1508), where the vehicle 1502 is in relation to the hole (e.g., based on GPS or other location data received from the vehicle 1502), and where the deployable accessory 1508 is in relation to the vehicle 1502 (e.g., triangulated based on deployable accessory aid devices 1505 on the vehicle 1502). In some instances, this automated shot tracking may be performed by the deployable accessory application and communicated to the context-based assistant application described herein for use by the context-based assistant application in generating and/or updating the user profile for the user as the user plays the round of golf.

As yet another example, in some embodiments, the deployable accessories 1508 may include a plurality of security drones (e.g., quadcopter drones) that have onboard cameras or other sensors onboard configured to monitor or survey an area (e.g., a construction site, a parking lot, etc.) for security purposes. Accordingly, the vehicle 1502 may drive to a location to be monitored or secured and selectively deploy the security drones, which may then perform an automated security/monitoring flight sequence (e.g., based on pre-programmed instructions and/or instructions received from the vehicle control system 1503 via the deployable accessory interface 1504 and the deployable accessory base 1506). Upon completion of their respective flight sequences, the various security drones may then be collected within the deployable accessory base 1506 and transported to another location.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removeable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10, the vehicle 210, the fleet monitoring and control system 400, the dock interface 700, the dynamic work interface 1200, and the vehicle system 1500, as well as the systems and components thereof, as shown in the various exemplary embodiments is illustrative only. Additionally, any element disclosed in one embodiment may be incorporated or utilized with any other embodiment disclosed herein.

1. A vehicle work management system comprising:
a plurality of work vehicles; and
a workflow management application utilizing one or more machine learning models, the workflow management application configured to:
acquire first workflow management information from the plurality of work vehicles;
acquire second workflow management information associated with a plurality of work items;
identify, using the one or more machine learning models, a work item of the plurality of work items for a work vehicle of the plurality of work vehicles based on the first workflow management information and the second workflow management information; and
provide the work item to the work vehicle.

2. The vehicle work management system of claim 1, wherein the first workflow management information includes vehicle location for the plurality of work vehicles, and the second workflow management information includes work item locations of the plurality of work items.

3. The vehicle work management system of claim 1, wherein the first workflow management information includes identities of operators of the plurality of work vehicles, and the second workflow management information includes credential information for the operators of the plurality of work vehicles and an indication of credentials required for the plurality of work items.

4. The vehicle work management system of claim 1, wherein the first workflow management information includes onboard tool information associated with onboard tools of the plurality of work vehicles, and the second workflow management information includes an indication of tools required for the plurality of work items.

5. The vehicle work management system of claim 4, wherein the onboard tool information includes a current charge level for an onboard tool of or on the work vehicle.

6. The vehicle work management system of claim 1, wherein the first workflow management information includes identities of operators of the plurality of work vehicles, and the second workflow management information includes work schedules of the operators of the plurality of work vehicles and expected durations of the plurality of work items.

7. The vehicle work management system of claim 1, wherein the workflow management application is configured to:
acquire work item progress information from the plurality of work vehicles regarding the plurality of work items; and
reassign the work item based on the work item progress information.

8. The vehicle work management system of claim 1, wherein providing the work item to the work vehicle includes:
generating a user interface including a map depicting a route from a vehicle location of the work vehicle to a work item location of the work item; and
provide the user interface to a display of the work vehicle to be displayed to an operator of the work vehicle.

9. The vehicle work management system of claim 8, wherein the workflow management application is configured to:
determine, using the one or more machine learning models, that the route requires access credentials for entering an area of a building; and
interface, using the one or more machine learning models, with an external system to request the access credentials for the operator of the work vehicle.

10. The vehicle work management system of claim 8, wherein the workflow management application is configured to:
determine, using the one or more machine learning models, that the route passes through an area requiring personal protection equipment; and
provide a notification to the work vehicle indicating that the area requires the personal protection equipment.

11. The vehicle work management system of claim 8, wherein the workflow management application is configured to create, using the one or more machine learning models, a geofence around the work item location.

12. The vehicle work management system of claim 11, wherein the workflow management application is configured to:
determine that the work vehicle has reached the work item location based on the work vehicle entering the geofence;
start a tracking timer to track a duration of the work item;
determine that the work item is complete based on the work vehicle exiting the geofence; and
stopping the tracking timer.

13. A vehicle work management system comprising:
at least one processing circuit having at least one processor and at least one memory having instructions stored thereon that, when executed by the at least one processor, cause the at least one processor to:
acquire vehicle locations for a plurality of work vehicles;
acquire work item locations of a plurality of work items;
identify, using one or more machine learning models, a work item from the plurality of work items for a work vehicle of the plurality of work vehicles based on the vehicle locations and the work item locations; and
provide the work item to the work vehicle.

14. The vehicle work management system of claim 13, wherein:
the instructions cause the at least one processor to:
acquire identities of operators of the plurality of work vehicles;
acquire credential information for the operators of the plurality of work vehicles; and
acquire an indication of credentials required for the plurality of work items from; and
identifying the work item is performed based on the credential information for the operators and the indication of the credentials required for the plurality of work items.

15. The vehicle work management system of claim 13, wherein:
the instructions cause the at least one processor to:
acquire onboard tool information associated with onboard tools of the plurality of work vehicles from the plurality of work vehicles; and
acquire an indication of tools required for the plurality of work items; and
identifying the work item is performed based on the onboard tool information and the indication of the tools required for the plurality of work items.

16. The vehicle work management system of claim 13, wherein providing the work item to the work vehicle includes:
generating a user interface including a map depicting a route from a vehicle location of the work vehicle to a work item location of the work item; and
providing the user interface to a display of the work vehicle to be displayed to an operator of the work vehicle.

17. The vehicle work management system of claim 16, wherein the instructions cause the at least one processor to create, using the one or more machine learning models, a geofence around the work item location.

18. A vehicle work management system comprising:
at least one processing circuit having at least one processor and at least one memory having instructions stored thereon that, when executed by the at least one processor, cause the at least one processor to:
acquire first workflow management information from a plurality of work vehicles;
acquire second workflow management information associated with a plurality of work items;
identify, using a machine learning application, a work item of the plurality of work items for a work vehicle of the plurality of work vehicles based on the first workflow management information and the second workflow management information;
generate, using the machine learning application, a map depicting a route from a vehicle location of the work vehicle to a work item location of the work item; and
providing the map to a display of the work vehicle to be displayed to an operator of the work vehicle.

19. The vehicle work management system of claim 18, wherein the instructions cause the at least one processor to:
receive work item progress information from the plurality of work vehicles regarding the plurality of work items; and
reassign, using the machine learning application, the work item to a different work vehicle based on the work item progress information.

20. The vehicle work management system of claim 18, wherein the instructions cause the at least one processor to create, using the machine learning application, a geofence around the work item location.
